(19) United States
(12) Patent Application Publication
(10) Pub. No.: US 2026/0293893 A1
(43) Pub. Date: Oct. 1, 2026

(54) COMPOSITION COMPRISING PHTHALIMIDE FUNGICIDE AND CO-FUNGICIDE

(71) Applicant: ADAMA MAKHTESHIM LTD., Beer Sheva (IL)

(72) Inventors: Liron HEVRONI, Meitar (IL); Hanan SERTCHOOK, Gedera (IL); Eliyahu SHMOELI, Petah Tikva (IL)

(73) Assignee: ADAMA MAKHTESHIM LTD., Beer Sheva (IL)

(21) Appl. No.: 19/100,700

(22) PCT Filed: Aug. 3, 2023
(86) PCT No.: PCT/IL2023/050811

§ 371 Date: Feb. 3, 2025

Related U.S. Application Data
(60) Provisional application No. 63/394,653, filed on Aug. 3, 2022.

(51) Int. Cl. A01N 43/38; A01N 31/02; A01N 43/40; A01N 43/56; A01N 59/06; A01P 3/00

(52) U.S. Cl. CPC A01N 43/38; A01N 31/02; A01N 43/40; A01N 43/56; A01N 59/06; A01P 3/00

(57) ABSTRACT

The present invention relates to a composition comprising (1) an amount of phthalimide fungicide, (2) an amount of at least one co-fungicide, (3) water and (4) an amount of carboxamide solvent of the Formula (A) wherein R represents C8 and higher alkyl chain, R1 and R2 represents H and/or C1-C6-alkyl. The present invention also provides methods of use of the compositions disclosed herein and processes of preparing the compositions disclosed herein.

Throughout this application various publications are referenced. The disclosures of these documents in their entireties are hereby incorporated by reference into this application in order to more fully describe the state of the art to which this invention pertains.

### TECHNICAL FIELD

The present invention is related to composition comprising (1) an amount of phthalimide fungicide, (2) an amount of at least one co-fungicide, (3) water and (4) an amount of carboxamide solvent of the Formula A.

R—CO—NR1R2 (A)
wherein R represents C8 and higher alkyl chain, R1 and R2 represents H and/or C1-C6-alkyl.

The present invention also provides methods of use of the composition disclosed herein and processes of preparing the composition disclosed herein.

### BACKGROUND

Combinations of phthalimide fungicide with different fungicides were found as very effective for controlling various pathogens on different crops.

Phthalimide fungicides are contact fungicides, which are very effective while a level of phytotoxicity can occur in the presence of a penetration enhancer. In addition, the phthalimide are very sensitive fungicides which are affected by different parameters. Known commercial products comprising phthalimide fungicide as solo active ingredient and in combination with additional fungicide are suspension concentrate and WDG. Other fungicides in absence of phthalimide may be formulated in different compositions such as suspension concentrate (SC), water dispersible granules (WDG), emulsifiable concentrate (EC) and emulsion concentrate (EW).

There is a need to develop a new chemically and physically stable liquid composition comprising phthalimide fungicide and other co-fungicide.

### SUMMARY OF THE INVENTION

The present invention provides a composition comprising (1) an amount of phthalimide fungicide, (2) an amount of at least one co-fungicide, (3) water and (4) an amount of carboxamide solvent of Formula A

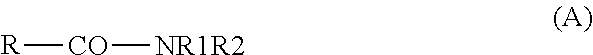

wherein R represents C8 and higher alkyl chain, R1 and R2 represents H and/or C1-C6-alkyl

In some embodiments, the composition further comprises pH adjuster.

In some embodiments, the present invention provides a composition comprising (1) an amount of phthalimide fungicide, (2) an amount of at least one co-fungicide, (3) water (4) pH adjuster and (5) an amount of carboxamide solvent of Formula A

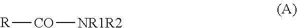

wherein R represents C8 and higher alkyl chain, R1 and R2 represents H and/or C1-C6-alkyl.

In some embodiments, the pH of the composition is between 3 to 6.

In some embodiments, the present invention provides a composition comprising (1) an amount of phthalimide fungicide, (2) an amount of at least one co-fungicide, (3) water and (4) an amount of carboxamide solvent of Formula A, R—CO—NR1R2 (A), wherein:
(a) R represents C8 and higher alkyl chain, R1 and R2 represent H and/or C1-C6-alkyl;
(b) the phthalimide fungicide is suspended in the water and (c) the co-fungicide is dissolved in the carboxamide solvent of Formula A.

In some embodiments, the co-fungicide is fluxapyroxad.

In some embodiment, the co-fungicide is fenpicoxamid.

The present invention provides a process for preparing a composition comprising phthalimide fungicide, at least one co-fungicide, water and carboxamide solvent of Formula A,

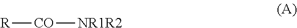

wherein R represents C8 and higher alkyl chain, R1 and R2 represents H and/or C1-C6-alkyl;
the process comprising:
   (1) preparing at least two separated compositions (A) and (B), wherein composition (A) is suspension concentrate (SC) composition of phthalimide fungicide and at least one surfactant, and composition (B) comprising co-fungicide, carboxamide solvent of Formula A and at least one surfactant, wherein the co fungicide is dissolved in carboxamide solvent of Formula A; and
   (2) mixing the two compositions (A) and (B) to obtain suspo-emulsion composition (SE).

The present invention provides a method of controlling fungal disease comprising applying to the plant or the locus of the plant a composition comprising (1) at least one co-fungicide; (2) at least one phthalimide fungicide, (3) water and (4) carboxamide solvent of Formula A

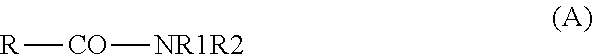

wherein: (a) R represents C8 and higher alkyl chain, R1 and R2 represent H and/or C1-C6-alkyl; (b) the phthalimide fungicide is suspended in the water and (c) the co-fungicide is dissolved in the carboxamide solvent of Formula A.

In some embodiments, the co-fungicide is fluxapyroxad.

In some embodiments, the co-fungicide is fenpicoxamid.

### DETAILED DESCRIPTION OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter belongs.

As used herein, an “agriculturally acceptable additive” is a compound that is known and accepted in the art for use in the formation of compositions for agricultural or horticultural use.

As used herein, the term “adjuvant” is defined as any substance that is not an active ingredient but which enhances or is intended to enhance the effectiveness of the active ingredient, for example pesticide, with which it is used. Adjuvants may include, but are not limited to, spreading agents, penetrants, compatibility agents, and drift retardants.

As used herein, the term “plant” includes reference to the whole plant, plant organ (e.g., leaves, stems, twigs, roots, trunks, limbs, shoots, fruits etc.), or plant cells.

As used herein, the term “plant” includes reference to agricultural crops including field crops (soybean, maize, wheat, rice, cereal, etc.), vegetable crops (potatoes, cabbages, etc.) and fruits (peach, etc.).

As used herein, the term “propagation material” is to be understood to denote all the generative parts of the plant such as seeds and spores, vegetative structures such as bulbs, corms, tubers, rhizomes, roots stems, basal shoots, stolons and buds.

As used herein, the term “locus” includes not only areas where insect may already exist, but also areas where insect has yet to emerge, and also to areas under cultivation.

As used herein, the term “stable” refers to pH of the composition before storage and/or after storage that is equal to or more than 3.

In some embodiments, storage refer to at least 1 year of storage at temperature up to 30° C.

In some embodiments, storage refer to any standard accelerated storage stability test (e.g. 2 weeks of storage at a temperature of 54° C.).

In some embodiments, pH remained between 3-6.

As used herein, the term “ha” refers to hectare.

The term “a” or “an” as used herein includes the singular and the plural, unless specifically stated otherwise. Therefore, the terms “a,” “an” or “at least one” can be used interchangeably in this application.

As used herein, the term “substantially free” when used in connection with a component in the composition means that the amount of the component in the composition is 0.1% w/w or less based on the total weight of the composition.

Throughout the application, descriptions of various embodiments use the term “comprising”; however, it will be understood by one of skill in the art, that in some specific instances, an embodiment can alternatively be described using the language “consisting essentially of” or “consisting of.”

The term “about” as used herein specifically includes ±10% from the indicated values in the range. In addition, the endpoints of all ranges directed to the same component or property herein are inclusive of the endpoints, are independently combinable, and include all intermediate points and ranges. It is understood that where a parameter range is provided, all integers within that range, and tenths thereof, are also provided by the invention. For example, “10-50%” includes 10%, 10.1%, 10.2%, etc. up to 50%.

Stability of suspoemulsion composition which comprises phthalimide fungicide and at least one co-fungicide, wherein the phthalimide is suspended in water and the co-fungicide is dissolved in a non-aqueous solvent is affected by different parameters such as type and amount of the non-aqueous solvents. In addition, the solubility of the non-aqueous solvent in water affects the stability of the concentrated composition and stability of the diluted composition in the tank.

It was found that carboxamide solvents of the Formula A

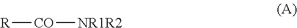

wherein R represents C8 and higher alkyl chain, R1 and R2 represents H and/or C1-C6-alkyl, which are known as penetration enhancer are compatible with phthalimide fungicide such as folpet and captan. Formulating phthalimide fungicide in presence of carboxamide solvent of Formula A and pH adjuster, allows maintaining the pH of the composition above 3.

Carboxamides solvent of the Formula A

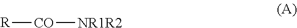

wherein R represents C8 and higher alkyl chain, R1 and R2 represents H and/or C1-C6-alkyl also disclosed as carboxamide solvent of Formula A.

In some embodiments, R is an unbranched or branched, saturated or unsaturated.

In some embodiments, R is C8-C20 alkyl chain such as n-octyl, n-decyl, n-decenyl.

In some embodiments, R1 and R2 are identical or different and are unbranched or branched.

Composition as well as their method s of use and processes of preparation, are described below.

The present invention provides a combination of (1) phthalimide fungicide and (2) carboxamide solvent of Formula A

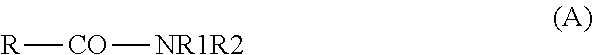

wherein R represents C8 and higher alkyl chain, R1 and R2 represent H and/or C1-C6-alkyl.

In some embodiments, the combination is a composition.

The present invention provides a composition comprising (1) an amount of phthalimide fungicide, (2) an amount of at least one co-fungicide, (3) water and (4) an amount of carboxamide solvent of Formula A

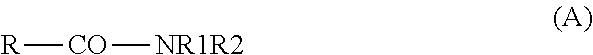

wherein R represents C8 and higher alkyl chain, R1 and R2 represents H and/or C1-C6-alkyl.

In some embodiments, the present invention provides a composition for controlling fungal disease comprising (1) at least one co-fungicide, (2) at least one phthalimide fungicide, (3) water and (4) carboxamide solvent of Formula A,

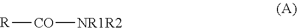

wherein: (a) R represents C8 and higher alkyl chain, R1 and R2 represent H and/or C1-C6-alkyl; (b) the phthalimide fungicide is suspended in the water and (c) the co-fungicide is dissolved in the carboxamide solvent of Formula A.

In some embodiments, the composition further comprises pH adjuster.

In some embodiments, the composition further comprising non polar solvent(s) In some embodiments, the co-fungicide(s) is dissolved in the mixture of carboxamide solvent of Formula A and non-polar solvent.

In some embodiments, the present invention provides a composition for controlling fungal disease comprising (1) at least one co-fungicide, (2) at least one phthalimide fungicide, (3) water and (4) mixture of carboxamide solvent of Formula A,

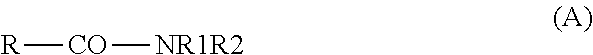

and non polar solvent,
wherein: (a) R represents C8 and higher alkyl chain, R1 and R2 represent H and/or C1-C6-alkyl; (b) the phthalimide fungicide is suspended in the water and (c) the co-fungicide is dissolved in the mixture of carboxamide solvent of Formula A and non polar solvent.

In some embodiments, the present invention provides a composition comprising (1) an amount of phthalimide fungicide, (2) an amount of at least one co-fungicide, (3) water (4) pH adjuster and (5) an amount of mixture of carboxamide solvent of Formula A

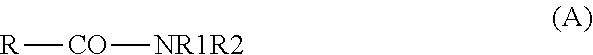

and non polar solvent, wherein R represents C8 and higher alkyl chain, R1 and R2 represents H and/or C1-C6-alkyl.

In some embodiments, the present invention provides a composition comprising (1) an amount of phthalimide fungicide, (2) an amount of at least one co-fungicide, (3) water (4) pH adjuster and (5) an amount of carboxamide solvent of Formula A

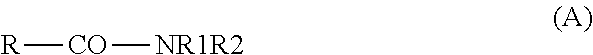

wherein R represents C8 and higher alkyl chain, R1 and R2 represents H and/or C1-C6-alkyl.

In some embodiments, the present invention provides a composition comprising (1) an amount of phthalimide fungicide, (2) an amount of at least one co-fungicide, (3) water (4) pH adjuster and (5) an amount of carboxamide solvent of Formula A

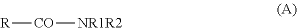

wherein R represents C8 and higher alkyl chain, R1 and R2 represents H and/or C1-C6-alkyl and (2) and the pH of the composition is equal to or more than 3.

In some embodiments, the present invention provides a composition comprising (1) an amount of phthalimide fungicide, (2) an amount of at least one co-fungicide, (3) water and (4) pH adjuster and (5) an amount of carboxamide solvent of Formula A

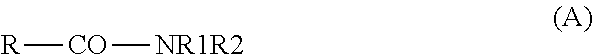

wherein R represents C8 and higher alkyl chain, R1 and R2 represents H and/or C1-C6-alkyl and (2) and the pH of the composition is between 3 to 6.

In some embodiments, the present invention provides a composition comprising (1) an amount of phthalimide fungicide, (2) an amount of at least one co-fungicide, (3) water and (4) pH adjuster and (5) an amount of mixture of carboxamide solvent of Formula A

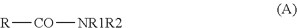

and non polar solvent, wherein (1) R represents C8 and higher alkyl chain, R1 and R2 represents H and/or C1-C6-alkyl and (2) the pH of the composition is equal to or more than 3.

In some embodiments, the present invention provides a composition comprising (1) an amount of phthalimide fungicide, (2) an amount of at least one co-fungicide, (3) water and (4) pH adjuster and (5) an amount of mixture of carboxamide solvent of Formula A

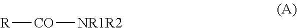

and non polar solvent, wherein (1) R represents C8 and higher alkyl chain, R1 and R2 represents H and/or C1-C6-alkyl and (2) the pH of the composition is between 3 to 6.

In some embodiments, the phthalimide fungicide is suspended in the water and the co-fungicide is dissolved in the carboxamide solvent of Formula A.

In some embodiments, the phthalimide fungicide is suspended in the water and the co-fungicide is dissolved in the mixture of carboxamide solvent of Formula A and nonpolar solvent.

In some embodiments, the present invention provides a composition comprising (1) an amount of phthalimide fungicide, (2) an amount of at least one co-fungicide, (3) water and (4) an amount of mixture of carboxamide solvent of Formula A

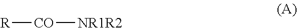

and non-polar solvent, wherein (1) R represents C8 and higher alkyl chain, R1 and R2 represents H and/or C1-C6-alkyl, (2) the phthalimide fungicide is suspended in the water and (3) the co-fungicide is dissolved in the mixture of carboxamide solvent of Formula A and nonpolar solvent.

In some embodiments, the present invention provides a composition comprising (1) an amount of phthalimide fungicide, (2) an amount of at least one co-fungicide, (3) water and (4) an amount of carboxamide solvent of Formula A

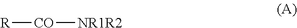

wherein (1) R represents C8 and higher alkyl chain, R1 and R2 represents H and/or C1-C6-alkyl, (2) the phthalimide fungicide is suspended in the water and (3) the co-fungicide is dissolved in the carboxamide solvent of Formula A.

In some embodiments, the composition further comprises pH adjuster.

In some embodiments, the present invention provides a composition comprising (1) an amount of phthalimide fungicide, (2) an amount of at least one co-fungicide, (3) water (4) pH adjuster and (5) an amount of mixture of carboxamide solvent of Formula A

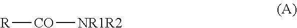

and nonpolar solvent, wherein (1) R represents C8 and higher alkyl chain, R1 and R2 represents H and/or C1-C6-alkyl, (2) the phthalimide fungicide is suspended in the water and (3) the co-fungicide is dissolved in the mixture of carboxamide solvent of Formula A and non polar solvent.

In some embodiments, the present invention provides a composition comprising (1) an amount of phthalimide fungicide, (2) an amount of at least one co-fungicide, (3) water (4) pH adjuster and (5) an amount of carboxamide solvent of Formula A

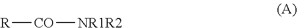

Wherein (1) R represents C8 and higher alkyl chain, R1 and R2 represents H and/or C1-C6-alkyl, (2) the phthalimide fungicide is suspended in the water and (3) the co-fungicide is dissolved in the carboxamide solvent of Formula A.

In some embodiments, the present invention provides a composition comprising (1) an amount of phthalimide fungicide, (2) an amount of at least one co-fungicide, (3) water (4) pH adjuster and (5) an amount of carboxamide solvent of Formula A

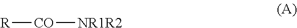

wherein (1) R represents C8 and higher alkyl chain, R1 and R2 represents H and/or C1-C6-alkyl and (2) and the pH of the composition is equal to or more than 3, (3) the phthalimide fungicide is suspended in the water and (4) the co-fungicide is dissolved in the carboxamide solvent of Formula A.

In some embodiments, the present invention provides a composition comprising (1) an amount of phthalimide fungicide, (2) an amount of at least one co-fungicide, (3) water and (4) pH adjuster and (5) an amount of carboxamide solvent of Formula A

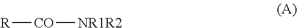

wherein (1) R represents C8 and higher alkyl chain, R1 and R2 represents H and/or C1-C6-alkyl and (2) and the pH of the composition is between 3 to 6, (3) the phthalimide fungicide is suspended in the water and (4) the co-fungicide is dissolved in the carboxamide solvent of Formula A.

In some embodiments, the present invention provides a composition comprising (1) an amount of phthalimide fungicide, (2) an amount of at least one co-fungicide, (3) water and (4) pH adjuster and (5) an amount of mixture of carboxamide solvent of Formula A

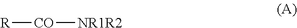

and non polar solvent, wherein (1) R represents C8 and higher alkyl chain, R1 and R2 represents H and/or C1-C6-alkyl and (2) the pH of the composition is equal to or more than 3, (3) the phthalimide fungicide is suspended in the water and (4) the co-fungicide is dissolved in the mixture of carboxamide solvent of Formula A and non polar solvent.

In some embodiments, the present invention provides a composition comprising (1) an amount of phthalimide fungicide, (2) an amount of at least one co-fungicide, (3) water and (4) pH adjuster and (5) an amount of mixture of carboxamide solvent of Formula A

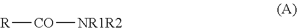

and non polar solvent, wherein (1) R represents C8 and higher alkyl chain, R1 and R2 represents H and/or C1-C6-alkyl (2) the pH of the composition is between 3 to 6, (3) the phthalimide fungicide is suspended in the water and (4) the co-fungicide is dissolved in the mixture of carboxamide solvent of Formula A and nonpolar solvent.

The present invention provides a composition comprising (1) an amount of phthalimide fungicide (2) an amount of at least one co-fungicide, (3) water and (4) carboxamide solvent of Formula A, wherein the phthalimide fungicide is suspended in water and the co-fungicide is dissolved in the carboxamide solvent of Formula A.

In some embodiments, the present invention provides a composition comprising (1) an amount of phthalimide fungicide, (2) an amount of at least one co-fungicide (3) water and (4) an amount of carboxamide solvent of Formula A, R—CO—NR1R2 (A), wherein:
(a) R represents C8 and higher alkyl chain, R1 and R2 represent H and/or C1-C6-alkyl;
(b) the phthalimide fungicide is suspended in the water and (c) the co-fungicide is dissolved in the carboxamide solvent of Formula A.

In some embodiments, co-fungicide is selected from the group consisting of fluxapyroxad, fenpicoxamid and any combination thereof.

In some embodiments, the co-fungicide is SDHI fungicide.

In some embodiments, the co-fungicide is fluxapyroxad.

In some embodiments, the co-fungicide is QiI fungicide.

In some embodiments, the co-fungicide is fenpicoxamid.

In some embodiments, phthalimide fungicide is selected from the group consisting of captan, folpet, captafol and any combination thereof.

In some embodiments, the phthalimide fungicide is folpet.

In some embodiments, the phthalimide fungicide is captan.

In some embodiments, the present invention provides a composition comprising (1) an amount of phthalimide fungicide is selected from the group consisting of captan, folpet, captafol and any combination thereof (2) an amount of at least one co-fungicide is selected from the group consisting of consisting of SDHI, QiI and any combination thereof, (3) water and (4) an amount of mixture of carboxamide solvent of Formula A

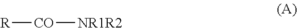

and non polar solvent, wherein (1) R represents C8 and higher alkyl chain, R1 and R2 represents H and/or C1-C6-alkyl, (2) the phthalimide fungicide is suspended in the water and (3) the co-fungicide is dissolved in the mixture of carboxamide solvent of Formula A and non polar solvent.

In some embodiments, the present invention provides a composition comprising (1) an amount of phthalimide fungicide is selected from the group consisting of captan, folpet, captafol and any combination thereof (2) an amount of at least one co-fungicide is selected from the group consisting of SDHI, QiI and any combination thereof, (3) water and (4) an amount of carboxamide solvent of Formula A

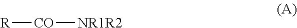

wherein R represents C8 and higher alkyl chain, R1 and R2 represents H and/or C1-C6-alkyl, (2) the phthalimide fungicide is suspended in the water and (3) the co-fungicide is dissolved in the carboxamide solvent of Formula A.

In some embodiments, the present invention provides a composition comprising (1) an amount of phthalimide fungicide is selected from the group consisting of captan, folpet, captafol and any combination thereof (2) an amount of at least one co-fungicide is selected from the group consisting of fluxapyroxad, fenpicoxamid and any combination thereof, (3) water and (4) an amount of mixture of carboxamide solvent of Formula A

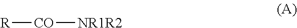

and non polar solvent, wherein (1) R represents C8 and higher alkyl chain, R1 and R2 represents H and/or C1-C6-alkyl, (2) the phthalimide fungicide is suspended in the water and (3) the co-fungicide is dissolved in the mixture of carboxamide solvent of Formula A and non polar solvent.

In some embodiments, the present invention provides a composition comprising (1) an amount of phthalimide fungicide is selected from the group consisting of captan, folpet, captafol and any combination thereof (2) an amount of at least one co-fungicide is selected from the group consisting of fluxapyroxad, fenpicoxamid and any combination thereof, (3) water and (4) an amount of carboxamide solvent of Formula A

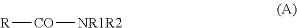

wherein R represents C8 and higher alkyl chain, R1 and R2 represents H and/or C1-C6-alkyl, (2) the phthalimide fungicide is suspended in the water and (3) the co-fungicide is dissolved in the carboxamide solvent of Formula A.

In some embodiments, the composition further comprises pH adjuster.

In some embodiments, the present invention provides a composition comprising (1) an amount of phthalimide fungicide is selected from the group consisting of captan, folpet, captafol and any combination thereof (2) an amount of at least one co-fungicide is selected from the group consisting of fluxapyroxad, fenpicoxamid and any combination thereof, (3) water (4) pH adjuster and (5) an amount of mixture of carboxamide solvent of Formula A

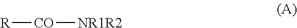

and non polar solvent, wherein R represents C8 and higher alkyl chain, R1 and R2 represents H and/or C1-C6-alkyl, (2) the phthalimide fungicide is suspended in the water and (3) the co-fungicide is dissolved in the mixture of carboxamide solvent of Formula A and non polar solvent.

In some embodiments, the present invention provides a composition comprising (1) an amount of phthalimide fungicide is selected from the group consisting of captan, folpet, captafol and any combination thereof (2) an amount of at least one co-fungicide is selected from the group consisting of fluxapyroxad, fenpicoxamid and any combination thereof, (3) water (4) pH adjuster and (4) an amount of carboxamide solvent of Formula A

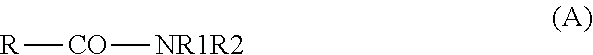

wherein R represents C8 and higher alkyl chain, R1 and R2 represents H and/or C1-C6-alkyl, (2) the phthalimide fungicide is suspended in the water and (3) the co-fungicide is dissolved in the carboxamide solvent of Formula A.

In some embodiments, the present invention provides a composition comprising (1) an amount of phthalimide fungicide is selected from the group consisting of captan, folpet, captafol and any combination thereof (2) an amount of at least one co-fungicide is selected from the group consisting of fluxapyroxad, fenpicoxamid and any combination thereof, (3) water (4) pH adjuster and (5) an amount of carboxamide solvent of Formula A

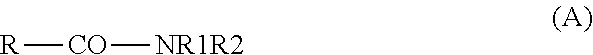

wherein R represents C8 and higher alkyl chain, R1 and R2 represents H and/or C1-C6-alkyl and (2) and the pH of the composition is equal to or more than 3, (3) the phthalimide fungicide is suspended in the water and (4) the co-fungicide is dissolved in the carboxamide solvent of Formula A.

In some embodiments, the present invention provides a composition comprising (1) an amount of phthalimide fungicide is selected from the group consisting of captan, folpet, captafol and any combination thereof (2) an amount of at least one co-fungicide is selected from the group consisting of fluxapyroxad, fenpicoxamid and any combination thereof, (3) water and (4) pH adjuster and (5) an amount of carboxamide solvent of Formula A

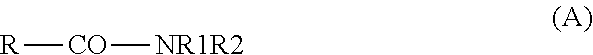

wherein R represents C8 and higher alkyl chain, R1 and R2 represents H and/or C1-C6-alkyl and (2) and the pH of the composition is between 3 to 6, (3) the phthalimide fungicide is suspended in the water and (4) the co-fungicide is dissolved in the carboxamide solvent of Formula A.

In some embodiments, the present invention provides a composition comprising (1) an amount of phthalimide fungicide is selected from the group consisting of captan, folpet, captafol and any combination thereof (2) an amount of at least one co-fungicide is selected from the group consisting of fluxapyroxad, fenpicoxamid and any combination thereof, (3) water and (4) pH adjuster and (5) an amount of mixture of carboxamide solvent of Formula A

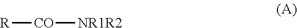

and non polar solvent, wherein (1) R represents C8 and higher alkyl chain, R1 and R2 represents H and/or C1-C6-alkyl and (2) the pH of the composition is equal to or more than 3, (3) the phthalimide fungicide is suspended in the water and (4) the co-fungicide is dissolved in mixture of carboxamide solvent of Formula A and non polar solvent.

In some embodiments, the present invention provides a composition comprising (1) an amount of phthalimide fungicide is selected from the group consisting of captan, folpet, captafol and any combination thereof (2) an amount of at least one co-fungicide is selected from the group consisting of fluxapyroxad, fenpicoxamid and any combination thereof, (3) water and (4) pH adjuster and (5) an amount of mixture of carboxamide solvent of Formula A

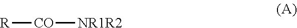

and nonpolar solvent, wherein (1) R represents C8 and higher alkyl chain, R1 and R2 represents H and/or C1-C6-alkyl (2) the pH of the composition is between 3 to 6, (3) the phthalimide fungicide is suspended in the water and (4) the co-fungicide is dissolved mixture of carboxamide solvent of Formula A and nonpolar solvent.

In some embodiments, the present invention provides a composition comprising (1) an amount of phthalimide fungicide, (2) an amount of fluxapyroxad, (3) water and (4) an amount of carboxamide solvent of Formula A

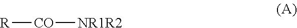

wherein R represents C8 and higher alkyl chain, R1 and R2 represent H and/or C1-C6-alkyl.

In some embodiments, the present invention provides a composition comprising (1) an amount of phthalimide fungicide, (2) an amount of fluxapyroxad, (3) water and (4) an amount of the dimethyl decan amide, wherein the phthalimide fungicide is suspended in the water and the fluxapyroxad is dissolved in the dimethyl decan amide.

In some embodiments, the composition further comprises pH adjuster.

In some embodiments, the amount of the pH adjuster is between 1% to about 5% w/w based on the total weight of the composition.

In some embodiments, the pH is equal to or more than 3.

In some embodiments, the pH is between 3 to 6.

In some embodiments, the pH is equal to or more than 3.5.

In some embodiments, the pH is between 4 to 5.

In some embodiments, the pH is between 3.5 to 6.

In some embodiments, the pH adjuster is a buffer system.

In some embodiments, composition further comprises buffer system.

In some embodiments, the buffer system is a combination of citric acid and a base such as citrate salt, hydroxide salt.

In some embodiments, the buffer system is a combination of acetic acid and a base such as acetate salt, hydroxide salt.

In some embodiments, the amount of the buffer system is between 1% to about 5% w/w based on the total weight of the composition.

In some embodiments, the composition is concentrated composition.

In some embodiments, concentrated refers to the composition before dilution with water (for example, in the tank).

In some embodiments, the composition is a ready-mix composition. In some embodiments, ready-mix refers to a concentrated composition. In some embodiments, the composition is storagable. In some embodiments, the composition is a stable composition.

In some embodiments, the composition is a suspo-emulsion composition (SE).

In some embodiments, the composition comprises additional co-fungicide(s) wherein the additional co-fungicide may be suspended in the water or dissolved in the mixture of carboxamide solvent of Formula A and non polar solvent.

In some embodiments, the composition comprises additional co-fungicide(s) wherein the additional co-fungicide may be suspended in the water or dissolved in the carboxamide solvent of Formula A.

In some embodiments, the phthalimide fungicide is folpet and the co-fungicide is SDHI fungicide.

In some embodiments, the phthalimide fungicide is folpet and the co-fungicide is fluxapyroxad.

In some embodiments, the phthalimide fungicide is captan and the co-fungicide is fluxapyroxad.

In some embodiments, the phthalimide fungicide is folpet and the co-fungicides are DMI fungicide and SDHI fungicide.

In some embodiments, the phthalimide fungicide is folpet and the co-fungicide are fenpropidin and SDHI fungicide.

In some embodiments, the phthalimide fungicide is folpet and the co-fungicides are DMI fungicide and QiI fungicide.

In some embodiments, the phthalimide fungicide is folpet and the co-fungicide is fenpicoxamid.

In some embodiments, the phthalimide fungicide is captan and the co-fungicide is fenpicoxamid.

In some embodiments the phthalimide is folpet and the co-fungicide are DMI fungicide and picoxystrobin.

In some embodiments, the phthalimide fungicide is folpet and the co-fungicides are SDHI fungicide and picoxystrobin.

In some embodiments, the R in the carboxamide solvent of Formula A comprises between 8-20 carbon atoms.

In some embodiments, the composition comprises two or more carboxamide solvents of Formula A

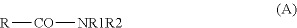

wherein R represents C8 and higher alkyl chain, R1 and R2 represent H and/or C1-C6-alkyl.

In some embodiments, R is an unbranched or branched, saturated or unsaturated.

In some embodiments, R1 and R2 are identical or different and an unbranched or branched.

In some embodiments the R is C8-C20 alkyl chain.

In some embodiments, the carboxamide solvent of Formula A is N,N-dimethyl-n-octanamide, N,N-dimethyl-n-nonanamide, N,N-dimethyl-n-decanamide, N,N-dimethyl-n-decenamide N,N-dimethyl-n-dodecanamide and combination thereof.

In some embodiments, the combination of carboxamide solvent of Formula A is, in particular N,N-dimethyl-n-octanamide and N,N-dimethyl-n-decanamide

In some embodiments, the carboxamide solvent of Formula A is a mixture of different carboxamide solvents of Formula A, wherein R, R1 and R2 are as defined in the present invention.

The carboxamide solvent of Formula A can be individual structure or in the form of mixture of different carboxamide solvents of Formula A, wherein R, R1 and R2 are as defined in the present invention.

Examples of carboxamide solvent of Formula A as individual structure or mixture are known under the trade names Hallcomid, Genagen or Agnique and which consists of (unless otherwise specified, all percentages are percent by weight).

For example 60-100% N,N dimethyl decanamide or for example 60-100% reaction mass of N,N-dimethyl decanamide and N,N dimethyl octanamide.

In some embodiments, the R1 and R2 groups in the carboxamide solvent of Formula A are methyl.

In some embodiments, the R in the carboxamide solvent of Formula A comprises 10 carbon atoms.

In some embodiments, the carboxamide solvent of Formula A is N,N-dimethyl-n-octanamide, N,N-dimethyl-n-nonanamide, N,N-dimethyl-n-decanamide, N,N-dimethyl-n-decenamide N,N-dimethyl-n-dodecanamide and combination thereof.

In some embodiments, carboxamide solvent of Formula A is dimethyl decan amide.

In some embodiments, the dimethyl decan amide is Genagen 4296.

In some embodiments, carboxamide solvent of Formula A is dimethyl decen amide.

In some embodiments, carboxamide solvent of Formula A is Dimethyl 9-decenamide.

In some embodiments, the dimethyl decen amide is Steposol MET-10U.

In some embodiments, the composition is stable.

In some embodiments, the amount of phthalimide fungicide in the composition is between about 1% to about 90% w/w based on the total weight of the composition. In some embodiments, the amount of phthalimide fungicide in the composition is between about 10% to about 80% w/w based on the total weight of the composition. In some embodiments, the amount of phthalimide fungicide in the composition is between about 20% to about 80% w/w based on the total weight of the composition. In some embodiments, the amount of phthalimide fungicide in the composition is between about 15% to about 60% w/w based on the total weight of the composition. In some embodiments, the amount of phthalimide fungicide in the composition is between about 15% to about 50% w/w based on the total weight of the composition. In some embodiments, the amount of phthalimide fungicide in the composition is between about 25% to about 35% w/w based on the total weight of the composition. In some embodiments, the amount of phthalimide fungicide in the composition is about 30% w/w based on the total weight of the composition.

In some embodiments, the amount of co-fungicide in the composition is about 1% w/w based on the total weight of the composition. In some embodiments, the amount of co-fungicide in the composition is between about 1% to about 50% w/w based on the total weight of the composition. In some embodiments, the amount of co-ungicide in the composition is between about 25% to about 35% w/w based on the total weight of the composition. In some embodiments, the amount of co-fungicide in the composition is between 1% to 15% w/w based on the total weight of the composition. In some embodiments, the amount of co-fungicide in the composition is between about 1% to about 10% w/w based on the total weight of the composition. In some embodiments, the amount of co-fungicide in the composition is between about 1% to about 5% w/w based on the total weight of the composition. In some embodiments, the amount of co-fungicide in the composition is between about 1.25% to about 30% w/w based on the total weight of the composition. In some embodiments, the amount of co-fungicide in the composition is about 2.5% to about 4.5% w/w based on the total weight of the composition.

In some embodiments, the amount of fluxapyroxad in the composition is about 1% w/w based on the total weight of the composition. In some embodiments, the amount of fluxapyroxad in the composition is between about 1% to about 50% w/w based on the total weight of the composition. In some embodiments, the amount of fluxapyroxad in the composition is between about 1.25% to about 30% w/w based on the total weight of the composition. In some embodiments, the amount of fluxapyroxad in the composition is about 2.5% to about 4.5% w/w based on the total weight of the composition.

The amount of one or more carboxamide solvent of Formula A can vary within wide limits, depending on the amount of the co-fungicide.

In some embodiments, the amount of carboxamide solvent of Formula A in the composition is between about 5% to 50% w/w based on the total weight of the composition. In some embodiments, the amount of carboxamide solvent of Formula A in the composition is about 8% to about 25% w/w based on the total weight of the composition. In some embodiments, the amount of carboxamide solvent of Formula A in the composition is about 8% to about 15% w/w based on the total weight of the composition.

In some embodiments, the amount of water in the composition is between about 20% to 90% w/w based on the total weight of the composition. In some embodiments, the amount of water in the composition is about 35% to about 45% w/w based on the total weight of the composition. In some embodiments, the amount of water in the composition is about 30% to about 45% w/w based on the total weight of the composition.

In some embodiments, the amount of mixture of carboxamide solvent of Formula A and non polar solvent in the composition is between about 5% to 50% w/w based on the total weight of the composition. In some embodiments, the amount of mixture of carboxamide solvent of Formula A and non polar solvent in the composition is about 8% to about 25% w/w based on the total weight of the composition. In some embodiments, the amount of mixture of carboxamide solvent of Formula A and non polar solvent in the composition is about 8% to about 15% w/w based on the total weight of the composition.

In some embodiments, the amount of non polar solvent of Formula A in the composition is between about 5% to 40% w/w based on the total weight of the composition. In some embodiments, the amount of non polar solvent in the composition is about 8% to about 25% w/w based on the total weight of the composition. In some embodiments, the amount of non polar solvent in the composition is about 8% to about 15% w/w based on the total weight of the composition.

In some embodiments, the weight ratio between the phthalimide fungicide and the carboxamide solvent of Formula A is between 1:3 to 4:1. In some embodiments, the weight ratio between the phthalimide fungicide and the carboxamide solvent of Formula A is between 1:1 to 3:1. In some embodiments, the weight ratio between the phthalimide fungicide and the carboxamide solvent of Formula A is about 1.7:1. In some embodiments, the weight ratio between the phthalimide fungicide and the carboxamide solvent of Formula A is about 1.7:1. In some embodiments, the weight ratio between the phthalimide fungicide and the carboxamide solvent of Formula A is above 1.75:1. In some embodiments, the weight ratio between the phthalimide fungicide and the carboxamide solvent of Formula A is between 1.75:1 to 2.2:1. In some embodiments, the weight ratio between the phthalimide fungicide and the carboxamide solvent of Formula A is between 2.8:1 to 3.3:1.

In some embodiments, the weight ratio between the folpet and the carboxamide solvent of Formula A is between 1:3 to 4:1. In some embodiments, the weight ratio between the folpet and the carboxamide solvent of Formula A is between 1:1 to 3:1. In some embodiments, the weight ratio between the folpet and the carboxamide solvent of Formula A is about 1.7:1. In some embodiments, the weight ratio between the folpet and the carboxamide solvent of Formula A is about 1.8:1. In some embodiments, the weight ratio between the folpet and the carboxamide solvent of Formula A is about 1.75:1. In some embodiments, the weight ratio between the Folpet and the carboxamide solvent of Formula A is between 1.85:1 to 2.2:1. In some embodiments, the weight ratio between the Folpet and the carboxamide solvent of Formula A is between 1.75:1 to 2.2:1. In some embodiments, the weight ratio between the Folpet and the carboxamide solvent of Formula A is between 2.8:1 to 3.3:1.

In some embodiments, the weight ratio between the captan and the carboxamide solvent of Formula A is between 1:3 to 4:1. In some embodiments, the weight ratio between the captan and the carboxamide solvent of Formula A is between 1:1 to 3:1. In some embodiments, the weight ratio between the captan and the carboxamide solvent of Formula A is about 1.7:1. In some embodiments, the weight ratio between the captan and the carboxamide solvent of Formula A is about 1.75:1. In some embodiments, the weight ratio between the Captan and the carboxamide solvent of Formula A is between 1.75:1 to 2.2:1. In some embodiments, the weight ratio between the Captan and the carboxamide solvent of Formula A is between 2.8:1 to 3.3:1.

In some embodiments, the weight ratio between the carboxamide solvent of Formula A to the co-fungicide is between about 3:1 to about 20:1. In some embodiments, the weight ratio between the carboxamide solvent of Formula A to the co-fungicide is between about 3:1 to about 10:1. In some embodiments, the weight ratio between the carboxamide solvent of Formula A to the co-fungicide is between about 3:1 to about 8:1. In some embodiments, the weight ratio between the carboxamide solvent of Formula A to the co-fungicide is between about 4:1 to about 7:1.

In some embodiments, the weight ratio between the carboxamide solvent of Formula A to the fluxapyroxad is between about 3:1 to about 20:1. In some embodiments, the weight ratio between the carboxamide solvent of Formula A to fluxapyroxad is between about 3:1 to about 10:1. In some embodiments, the weight ratio between the carboxamide solvent of Formula A to fluxapyroxad is between about 4:1 to about 8:1.

In some embodiments, the weight ratio between the carboxamide solvent of Formula A to fluxapyroxad is between about 4:1 to about 7:1 In some embodiments, the weight ratio between the carboxamide solvent of Formula A to the fenpicoxamid is between about 3:1 to about 20:1. In some embodiments, the weight ratio between the carboxamide solvent of Formula A to fenpicoxamid is between about 3:1 to about 10:1. In some embodiments, the weight ratio between the carboxamide solvent of Formula A to fenpicoxamid is between about 4:1 to about 8:1.

In some embodiments, the weight ratio between the carboxamide solvent of Formula A to fenpicoxamid is between about 4:1 to about 7:1

In some embodiments, the composition comprises two co-fungicides

In some embodiments, the composition comprises more than two co-fungicide.

In some embodiments, the phthalimide fungicide is suspended in the water, one co-fungicide is suspended in the water and the second is dissolved in the carboxamide solvent of Formula A.

In some embodiments, the phthalimide fungicide is suspended in the water, the co-fungicides are dissolved in the carboxamide solvent of Formula A.

In some embodiments, when the composition comprises two or more co-fungicides, the phthalimide fungicide is suspended in the water, and at least one co-fungicide is dissolved in the carboxamide solvent of Formula A.

In some embodiments, when the composition comprises two or more co-fungicide, the phthalimide fungicide is suspended in the water, at least one co-fungicide is dissolved in the carboxamide solvent of Formula A and at least one co-fungicide is suspended in the water.

In some embodiments, when the composition comprises two or more co-fungicides, the phthalimide fungicide is suspended in the water, at least two co-fungicides are dissolved in carboxamide solvent of Formula A.

In some embodiments, the one co-fungicide is suspended in the water and the second is dissolved in the carboxamide solvent of Formula A.

In some embodiments, the co-fungicides are dissolved in the carboxamide solvent of Formula A.

In some embodiments, when the composition comprises two or more co-fungicides, at least one co-fungicide is dissolved in the carboxamide solvent of Formula A.

In some embodiments, when the composition comprises two or more co-fungicide, at least one co-fungicide is dissolved in the carboxamide solvent of Formula A and at least one co-fungicide is suspended in the water.

In some embodiments, when the composition comprises two or more co-fungicides, at least two co-fungicides are dissolved in the carboxamide solvent of Formula A In some embodiments, the phthalimide fungicide is suspended in the water, one co-fungicide is suspended in the water and the second is dissolved in the mixture of carboxamide solvent of Formula A and non polar solvent.

In some embodiments, the phthalimide fungicide is suspended in the water, the co-fungicides are dissolved in the mixture of carboxamide solvent of Formula A and nonpolar solvent.

In some embodiments, when the composition comprises two or more co-fungicides, the phthalimide fungicide is suspended in the water, and at least one co-fungicide is dissolved in the mixture of carboxamide solvent of Formula A and non polar solvent.

In some embodiments, when the composition comprises two or more co-fungicide, the phthalimide fungicide is suspended in the water, at least one co-fungicide is dissolved in the mixture of carboxamide solvent of Formula A and non polar solvent and at least one co-fungicide is suspended in the water.

In some embodiments, when the composition comprises two or more co-fungicides, the phthalimide fungicide is suspended in the water, at least two co-fungicides are dissolved in the mixture of carboxamide solvent of Formula A and nonpolar solvent.

In some embodiments, the one co-fungicide is suspended in the water and the second is dissolved in the mixture of carboxamide solvent of Formula A and nonpolar solvent.

In some embodiments, the co-fungicides are dissolved in the mixture of carboxamide solvent of Formula A and nonpolar solvent. In some embodiments, when the composition comprises two or more co-fungicides, at least one co-fungicide is dissolved in the mixture of carboxamide solvent of Formula A and non polar solvent.

In some embodiments, when the composition comprises two or more co-fungicide, at least one co-fungicide is dissolved in the mixture of carboxamide solvent of Formula A and nonpolar solvent and at least one co-fungicide is suspended in the water.

In some embodiments, when the composition comprises two or more co-fungicides, at least two co-fungicides are dissolved in the mixture of carboxamide solvent of Formula A and nonpolar solvent.

In some embodiments, the weight ratio between the phthalimide fungicide and the co-fungicide is 80:1 to 1:80. In some embodiments the weight ratio between phthalimide fungicide to co fungicide(s) is 30:1 to 1:1. In some embodiments, the weight ratio between phthalimide fungicide to co-fungicide(s) is 20:1 to 1:1. In some embodiments, the weight ratio between phthalimide fungicide to co-fungicide(s) is 20:1 to 1:1. In some embodiments, the weight ratio between phthalimide fungicide to co-fungicide(s) is 12:1 to 1:1. In some embodiments, the weight ratio between phthalimide fungicide to co-fungicide(s) is 8:1 to 1:1

In some embodiments, the ratio among phthalimide fungicide and the co-fungicide SDHI fungicide is 1:0.06. In some embodiments, the ratio among phthalimide fungicide and the co-fungicide SDHI fungicide is 1:0.8. In some embodiments, the ratio among phthalimide fungicide and the co-fungicide SDHI fungicide is 1:0.1. In another embodiment the ratio is 1:0.12. In some embodiments, the ratio among phthalimide fungicide and the co-fungicide SDHI fungicide is 1:0.17.

In some embodiments, the weight ratio between phthalimide fungicide to fluxapyroxad is 30:1 to 1:1. In some embodiments, the weight ratio between phthalimide fungicide to fluxapyroxad is 20:1 to 1:1. In some embodiments, the weight ratio between phthalimide fungicide to fluxapyroxad is 20:1 to 1:1. In some embodiments, the weight ratio between phthalimide fungicide to fluxapyroxad is 12:1 to 1:1. In some embodiments, the weight ratio between phthalimide fungicide to fluxapyroxad is 8:1 to 1:1

In some embodiments, the weight ratio between folpet to fluxapyroxad is 30:1 to 1:1.

In some embodiments, the weight ratio between folpet to fluxapyroxad is 20:1 to 1:1.

In some embodiments, the weight ratio between folpet to fluxapyroxad is 20:1 to 1:1.

In some embodiments, the weight ratio between folpet to fluxapyroxad is 12:1 to 1:1.

In some embodiments, the weight ratio between folpet to fluxapyroxad is 8:1 to 1:1

In some embodiments, the weight ratio between captan to fluxapyroxad is 30:1 to 1:1.

In some embodiments, the weight ratio between captan to fluxapyroxad is 20:1 to 1:1.

In some embodiments, the weight ratio between captan to fluxapyroxad is 20:1 to 1:1.

In some embodiments, the weight ratio between captan to fluxapyroxad is 12:1 to 1:1.

In some embodiments, the weight ratio between captan to fluxapyroxad is 8:1 to 1:1

In some embodiments, the ratio among phthalimide fungicide and the co-fungicides DMI fungicide and SDHI fungicide is 1:0.03:0.375. In some embodiments, the ratio among phthalimide fungicide and the co-fungicides DMI fungicide and SDHI fungicide is 0.05:0.625:1. In some embodiments, the ratio among phthalimide fungicide and the co-fungicides DMI fungicide and SDHI fungicide is 1:0.08:0.8. In some embodiments, the ratio among phthalimide fungicide and the co-fungicides DMI fungicide and SDHI fungicide is 0.08:1:1.

In some embodiments, the ratio among phthalimide fungicide and the co-fungicides fenpropidin fungicide and SDHI fungicide is 1:0.03:0.3. In some embodiments, the ratio among phthalimide fungicide and the co-fungicides fenpropidin fungicide and SDHI fungicide is 1:0.03:0.2. In some embodiments, the ratio among phthalimide fungicide and the co-fungicides fenpropidin fungicide and SDHI fungicide is 1:0.03: 0.15. In some embodiments, the ratio among phthalimide fungicide and the co-fungicides fenpropidin fungicide and SDHI fungicide is 1:0.05:0.5. In some embodiments, the ratio among phthalimide fungicide and the co-fungicides fenpropidin fungicide and SDHI fungicide is 1:0.05:0.33. In another embodiment the ratio is 1:0.05:0.25. In some embodiments, the ratio among phthalimide fungicide and the co-fungicides fenpropidin fungicide and SDHI fungicide is 1:0.08:0.8. In some embodiments, the ratio among phthalimide fungicide and the co-fungicides fenpropidin fungicide and SDHI fungicide is 1:0.08:0.533. In some embodiments, the ratio among phthalimide fungicide and the co-fungicides fenpropidin fungicide and SDHI fungicide is 1:0.08:0.4.

In some embodiments the weight ratio between phthalimide fungicide to fenpicoxamid is 30:1 to 1:1. In some embodiments, the weight ratio between phthalimide fungicide to fenpicoxamid is 30:1 to 1:1. In some embodiments, the weight ratio between phthalimide fungicide to fenpicoxamid is 20:1 to 1:1. In some embodiments, the weight ratio between phthalimide fungicide to fenpicoxamid is 12:1 to 1:1. In some embodiments, the weight ratio between phthalimide fungicide to fenpicoxamid is 8:1 to 1:1.

In some embodiments the weight ratio between folpet to fenpicoxamid is 30:1 to 1:1.

In some embodiments, the weight ratio between folpet to fenpicoxamid is 30:1 to 1:1.

In some embodiments, the weight ratio between folpet to fenpicoxamid is 20:1 to 1:1.

In some embodiments, the weight ratio between folpet to fenpicoxamid is 12:1 to 1:1.

In some embodiments, the weight ratio between folpet to fenpicoxamid is 8:1 to 1:1.

In some embodiments the weight ratio between captan to fenpicoxamid is 30:1 to 1:1.

In some embodiments, the weight ratio between captan to fenpicoxamid is 30:1 to 1:1.

In some embodiments, the weight ratio between captan to fenpicoxamid is 20:1 to 1:1.

In some embodiments, the weight ratio between captan to fenpicoxamid is 12:1 to 1:1.

In some embodiments, the weight ratio between captan to fenpicoxamid is 8:1 to 1:1.

In some embodiments, the ratio among phthalimide fungicide and the co-fungicides DMI fungicide and picoxystrobin fungicide is 1:0.08:1.3. In some embodiments, the ratio among phthalimide fungicide and the co-fungicides DMI fungicide and picoxystrobin fungicide is 1:0.1:1.7.

In some embodiments, the ratio among phthalimide fungicide and the co-fungicides SDHI fungicide and picoxystrobin fungicide is 1:0.03:0.5. In some embodiments, the ratio among phthalimide fungicide and the co-fungicides SDHI fungicide and picoxystrobin fungicide 0.05:0.8:1. In some embodiments, the ratio among phthalimide fungicide and the co-fungicides SDHI fungicide and picoxystrobin fungicide 1:0.08:1.3.

In some embodiments, the carboxamide solvent of Formula A is as described above.

In some embodiments, the composition further comprises non polar solvent(s).

In some embodiments, nonpolar solvent may include but is not limited to aromatic hydrocarbons (e.g. toluene, o-, m-, p-xylene, ethylbenzene, isopropylbenzene, tert-butylbenzene, naphthalenes, mono- or polyalkyl-substituted naphthalenes), paraffins (e.g. octane, nonane, decane, undecane, dodecane, tridecane, tetradecane, pentadecane, hexadecane, hepta-decane, octa-decane, nona-decane, eicosane, heneicosane, docosane, tricosane, tetracosane, pentacosane, and branched chain isomers thereof), petroleum, diesel, mineral oil.

In some embodiments, the composition is substantially free of non polar solvent.

In some embodiments, the mixture of carboxamide solvent of Formula A and nonpolar solvent further comprises additive such as surfactant.

In some embodiments, the composition further comprises at least one surfactant.

In some embodiments, the composition comprises at least two surfactants.

In some embodiments, the amount of the surfactant(s) in the composition is between about 3% to about 15% w/w based on the total weight of the composition. In some embodiments, the amount of the surfactant(s) in the composition is between about 5% to about 10% w/w based on the total weight of the composition. In some embodiments, the amount of the surfactant(s) is about 6.5% to about 8.5% w/w based on the total weight of the composition.

In some embodiments, the surfactant is dispersing agent, emulsifier and/or wetting agent.

In some embodiments, more than one dispersing agent, emulsifier and/or wetting agent is used.

In some embodiments, the dispersing agent is selected from the group consisting of polyglycol ethers, Polyalkylene oxide block copolymer (such as atlas G5002L, Ethylan NS 500 LQ, Antarox B/848), ethoxylated fatty alcohol, castor oil ethoxylate, ethoxylated aryl alcohol, their ether phosphates and salts thereof (such as amine salt of Polyarylphenyl ether phosphate), ethoxylated tristyryl phenol, Poly-ether modified Trisiloxane, methyl methacrylate-polyethylene glycol graft copolymer (such as atlox 4913 and tersperse 2500), condensate of alkyl naphthalene sulfonate formaldehyde, lignosulfonates, silicone surfactant, methyl naphthalene sulfonate condensate, sodium salt, polyelectrolyte block copolymer (as described in WO2017/098325) and any combination thereof. In some embodiments, the dispersing agent is a block polymer comprising 77% of sodium 2-acryloylamino-2-methylpropane-1-sulfonate (AMPS) monomers and 23% of the ethyl acrylate (EA) monomers.

In some embodiments, the dispersing agent is a water solution of 30% by weight solution of a block polymer comprising 77% of sodium 2-acryloylamino-2-methylpropane-1-sulfonate (AMPS) monomers and 23% of ethyl acrylate (EA) monomers, which may be prepared as described in Example 1 of WO2017/098325.

In some embodiments, the dispersing agent is a methyl methacrylate-polyethylene glycol graft copolymer.

In some embodiments, the dispersing agents are a water solution of 30% by weight solution of a block polymer comprising 77% of sodium 2-acryloylamino-2-methylpropane-1-sulfonate (AMPS) monomers and 23% of ethyl acrylate (EA) monomers, which may be prepared as described in Example 1 of WO2017/098325, and a methyl methacrylate-polyethylene glycol graft copolymer.

In some embodiments, the wetting agent, is dioctyl sulfosuccinate (such as Lankropol KO2) alcohol ethoxylate, sodium lauryl sulfate, sodium alkyl naphthalene sulfonate or combination thereof.

In some embodiments, the composition further comprises emulsifier.

In some embodiments, the emulsifier is soluble in the carboxamide solvent of Formula A.

In some embodiments, the emulsifier is soluble in the mixture of carboxamide solvent of Formula A and non polar solvent.

In some embodiments, the emulsifier is for reducing the solubility of carboxamide solvent of Formula A in the water.

In some embodiments, the emulsifier agent is Sodium Dioctyl sulfosuccinate (such as aerosol OT-SE), Soprophor ts-10 (ethoxylated tristyryl phenol), Atlox 4912 (ABA Block copolymer), alkylated Benzenesulfonic acid calcium salt, Castor oil ethoxylate and combination thereof.

In some embodiments, same surfactant may function in different roles (wetting, emulsifier, dispersing agent).

The role is dependent on the composition type (SC, EC, EW) which is used for preparing the invention composition.

In some embodiments, the amount of emulsifier agent which is dissolved in the carboxamide solvent of Formula A is up to about 2% w/w based on the total weight of the composition.

In some embodiments, the pH of the composition is between 3 to 6.

In some embodiments, the pH is equal to or more than 3.

In some embodiments, composition further comprises buffer system.

In some embodiments, the buffer system is a combination of citric acid and a base such as citrate salt, hydroxide salt.

In some embodiments, the buffer system is a combination of acetic acid and a base such as acetate salt, hydroxide salt.

In an embodiment, the buffer system comprising a mixture of acetic acid and acetic acid sodium, potassium or ammonium salt.

In another embodiment, the buffer system comprising a mixture of citric acid and citric acid sodium, potassium or ammonium salt.

In some embodiments, the amount of the buffer system is between 1% to about 5% w/w based on the total weight of the composition.

In some embodiments, the viscosity of the composition is between 900 to 2000 cP. (measured by Brookefield viscometer, Spindle 63, 12 RPM).

In some embodiments, the composition further comprises rheological modifier.

In some embodiments, the rheological modifier is a clay based rheological modifier additive such as Van Gel B (Magnesium Aluminum Silicate), Bentone EW (Hectorite), Bentone LT (Smectite), Attagel (Attepulgite).

In some embodiments, the clay based rheological modifier is Van Gel B (Magnesium Aluminum Silicate).

In some embodiments, the clay is combined with a xanthan gum (oligosaccharide modifier).

In some embodiments, the rheological modifier is a silica based rheological modifier additive such as Aerosil 200, Aerosil 380, Cab-O-Sil M5.

In some embodiments, the silica based rheological modifier is Cab-O-Sil M5.

In some embodiments, the silica is combined with a xanthan gum (oligosaccharide modifier).

In some embodiments, the composition further comprises at least one additive such as anti-foaming agent, biocides, adjuvants, antifreeze.

In some embodiments, the composition further comprises a polyelectrolyte complex.

In some embodiments, the polyelectrolyte complex is as described in WO 2013/133705 and WO 2013/133706.

In some embodiments, the polyelectrolyte complex is a complex of a polycation and a polyanion.

In some embodiments, the present invention provides a composition comprising:
(1) folpet in amount of about 25% to about 35% w/w based on the total weight of the composition,
(2) fluxapyroxad in amount of about 1.5% to about 10% w/w based on the total weight of the composition,
(3) water in amount of about 20% to about 50% w/w based on the total weight of the composition and
(4) carboxamide solvent of Formula A in amount of about 10% to about 25% w/w based on the total weight of the composition.

In some embodiments, the present invention provides a composition comprising:
(1) folpet in amount of about 30% w/w based on the total weight of the composition,
(2) fluxapyroxad in amount of about 3.5% w/w based on the total weight of the composition,
(3) water in amount of about 37% w/w based on the total weight of the composition and
(4) carboxamide solvent of Formula A in amount of about 15% w/w based on the total weight of the composition.

In some embodiments, the present invention provides a composition comprising:
(1) folpet in amount of about 30% w/w based on the total weight of the composition,
(2) fluxapyroxad in amount of about 3.5% w/w based on the total weight of the composition,
(3) water in amount of about 37% w/w based on the total weight of the composition and
(4) genagen 4296 in amount of about 15% w/w based on the total weight of the composition.

In some embodiments, the present invention provides a composition comprising:
(1) captan in amount of about 30.5% w/w based on the total weight of the composition,
(2) fluxapyroxad in amount of about 2.5% w/w based on the total weight of the composition.
(3) water in amount of about 41% w/w based on the total weight of the composition and
(4) carboxamide solvent of Formula A in amount of about 9.6% w/w based on the total weight of the composition.

In some embodiments, the composition further comprising pH adjuster.

In some embodiments, the pH adjuster is a buffer system.

In some embodiments, the present invention provides a composition comprising:
(1) folpet in amount of about 25% to about 35% w/w based on the total weight of the composition,
(2) fluxapyroxad in amount of about 1.5% to about 10% w/w based on the total weight of the composition,
(3) water in amount of about 20% to about 50% w/w based on the total weight of the composition,
(5) carboxamide solvent of Formula A in amount of about 10% to about 25% w/w based on the total weight of the composition and
(6) pH adjuster

In some embodiments, the present invention provides a composition comprising:
(1) folpet in amount of about 30% w/w based on the total weight of the composition,
(2) fluxapyroxad in amount of about 3.5% w/w based on the total weight of the composition,
(3) water in amount of about 37% w/w based on the total weight of the composition and
(4) carboxamide solvent of Formula A in amount of about 15% w/w based on the total weight of the composition and
(5) pH adjuster

In some embodiments, the present invention provides a composition comprising:
(1) folpet in amount of about 30% w/w based on the total weight of the composition,
(2) fluxapyroxad in amount of about 3.5% w/w based on the total weight of the composition,
(3) water in amount of about 37% w/w based on the total weight of the composition and
(4) genagen 4296 in amount of about 15% w/w based on the total weight of the composition and
(5) pH adjuster

In some embodiments, the amount of the pH adjuster is between 1% to about 5% w/w based on the total weight of the composition.

In some embodiments, pH adjuster is buffer system.

In some embodiments, the buffer system is a combination of citric acid and a base such as citrate salt, hydroxide salt.

In some embodiments, the amount of the buffer system is between 1% to about 5% w/w based on the total weight of the composition.

In some embodiments, the present invention provides a composition comprising:
(1) captan in amount of about 30.5% w/w based on the total weight of the composition,
(2) fluxapyroxad in amount of about 2.5% w/w based on the total weight of the composition.
(3) water in amount of about 41% w/w based on the total weight of the composition and
(4) carboxamide solvent of Formula A in amount of about 9.6% w/w based on the total weight of the composition.
(5) pH adjuster

In some embodiments, the amount of the pH adjuster is between 1% to about 5% w/w based on the total weight of the composition. In some embodiments, pH adjuster is buffer system.

In some embodiments, the buffer system is combination of acetic acid and a base such as acetate salt, hydroxide salt.

In some embodiments, the amount of the buffer system is between 1% to about 5% w/w based on the total weight of the composition.

### Process for Preparing

The present invention provides a process for preparing a composition comprising phthalimide fungicide, at least one co-fungicide, water and carboxamide solvent of Formula A,

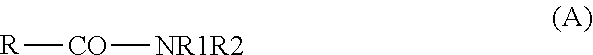

wherein R represents C8 and higher alkyl chain, R1 and R2 represents H and/or C1-C6-alkyl;
the process comprising:
   (1) preparing at least two separated compositions (A) and (B), wherein composition (A) is suspension concentrate (SC) composition of phthalimide fungicide and at least one surfactant, and composition (B) comprising co-fungicide, carboxamide solvent of Formula A and at least one surfactant, wherein the co fungicide is dissolved in carboxamide solvent of Formula A; and
   (2) mixing the two compositions (A) and (B) to obtain suspo-emulsion composition (SE).

In some embodiments, the composition (B) is emulsifiable concentrate (EC)

in some embodiments the composition (B) is concentrated emulsion (EW).

In some embodiments, the composition (A) further comprises surfactant(s).

In some embodiments, the at least one surfactant in compositions (A) and (B) is the same.

In some embodiments, the buffer is part of the SC composition.

In some embodiments, when the composition (B) is EW, it may further comprise a buffer system.

In some embodiments, both compositions (A) and (B) comprise buffer.

In some embodiments, the SC composition comprises rheologic modifier(s).

In some embodiments, the EW composition comprises rheologic modifier(s).

In some embodiments, the rheologic modifier is added to the SE composition.

In some embodiments, the composition comprising co-fungicide, carboxamide solvent of Formula A and at least one surfactant, further comprises at least one emulsifier.

In some embodiments, the phthalimide fungicide is formulated as suspension concentrate (SC)

In some embodiments, the composition (B) which comprises the co-fungicide is prepared by (i) preparing EC composition comprising the co-fungicide and (ii) mixing with water to obtain concentrated emulsion (EW).

In some embodiments, the composition (B) which comprises co-fungicide is prepared by combining a water phase and an organic phase to obtain concentrated emulsion (EW).

In some embodiments, the EW composition further comprises, buffer, antifreeze, surfactant(s) and emulsifier(s).

### Method for Treatment

The present invention provides a method of controlling fungal disease comprising applying to the plant or the locus of the plant a composition comprising (a) at least one co-fungicide; and b) at least one phthalimide fungicide, (c) water and (d) carboxamide solvent of Formula A.

The present invention provides a method of controlling fungal disease comprising applying to the plant or the locus of the plant a composition comprising (1) at least one co-fungicide, (2) at least one phthalimide fungicide, (3) water and (4) carboxamide solvent of Formula A,

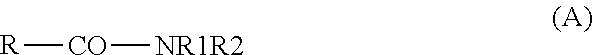

wherein: (a) R represents C8 and higher alkyl chain, R1 and R2 represent H and/or C1-C6-alkyl; (b) the phthalimide fungicide is suspended in the water and (c) the co-fungicide is dissolved in the carboxamide solvent of Formula A.

The present invention provides a method of controlling fungal disease comprising applying to the plant or the locus of the plant a composition comprising (1) at least one co-fungicide, (2) at least one phthalimide fungicide, (3) water and (4) mixture of carboxamide solvent of Formula A,

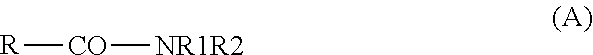

and non polar solvent, wherein: (a) R represents C8 and higher alkyl chain, R1 and R2 represent H and/or C1-C6-alkyl; (b) the phthalimide fungicide is suspended in the water and (c) the co-fungicide is dissolved in the mixture of carboxamide solvent of Formula A and non polar solvent.

In some embodiments, the co-fungicide is fluxapyroxad.

In some embodiment, the co-fungicide is fenpicoxamid.

In some embodiments, the phthalimide fungicide is folpet.

In some embodiments, the phthalimide fungicide is captan.

In some embodiments, the composition of the present invention can be combined with additional pesticide such as fungicide and/or insecticide.

Non-limiting examples of pathogens of fungal diseases which may be treated in accordance with the invention include: diseases caused by powdery mildew pathogens, for example Blumeria species, for example Blumeria graminis, Podosphaera species, for example Podosphaera leucotricha, Sphaerotheca species, for example Sphaerotheca fuliginea, Uncinula species, for example Uncinula necator, for example Erysiphe species; diseases caused by rust disease pathogens, for example Gymnosporangium species, for example Gymnosporangium sabinae; Hemileia species, for example Hemileia vastatrix; Phakopsora species, for example Phakopsora pachyrhizi or Phakopsora meibomiae Puccinia species, for example Puccinia recondita, Puccinia graminis oder Puccinia striiformis, Uromyces species, for example Uromyces app endiculatus, diseases caused by pathogens from the group of the Oomycetes, for example Albugo species, for example Albugo Candida, Bremia species, for example Bremia laciucaer, Peronospora species, for example Peronospora pisi or P. brassicaer, Phytophthora species, for example Phytophthora infestans, Plasmopara species, for example Plasmopara viticola, Pseudoperonospora species, for example Pseudoperonospora humuli or Pseudoperonospora cubensis, Pythium species, for example Pythium ultimunv, leaf blotch diseases and leaf wilt diseases caused, for example, by Alternaria species, for example Alternaria solanv, Cercospora species, for example Cercospora beticola, Cladiosporium species, for example Cladiosporium cucumerinunr, Cochliobolus species, for example Cochliobolus sativus (conidial form: Drechslera, syn: Helminthosporium) or Cochliobolus miyabeanus, Colletotrichum species, for example Colletotrichum lindemuthaniunv, Corynespora species, for example Corynespora cassiicola, Cycloconium species, for example Cycloconium oleaginunv, Diaporthe species, for example Diaporthe citrv, Elsinoe species, for example Elsinoe fawcettii, Gloeosporium species, for example Gloeosporium laeticolor, Glomerella species, for example Glomerella cingulata, Guignardia species, for example Guignardia bidwellv, Leptosphaeria species, for example Leptosphaeria maculans, Magnaporthe species, for example Magnaporthe grisea, Microdochium species, for example Microdochium nivaler, Mycosphaerella species, for example Mycosphaerella graminicola (also known as Septoria tritici), Mycosphaerella arachidicola or Mycosphaerella fijiens, Phaeosphaeria species, for example Phaeosphaeria nodorunr, Pyrenophora species, for example Pyrenophora teres or Pyrenophora tritici repenth, Ramularia species, for example Ramularia collo-cygni or Ramularia areola, Rhynchosporium species, for example Rhynchosporium secalis, Septoria species, for example Septoria apii or Septoria lycopersicv, Stagonospora species, for example Stagonospora nodorunr, Typhula species, for example Typhula incarnata, Venturia species, for example Venturia inaequal, root and stem diseases caused, for example, by Corticium species, for example Corticium graminearum, Fusarium species, for example Fusarium oxysporum\Gaeumannomyces species, for example Gaeumannomyces graminis, Plasmodiophora species, for example Plasmodiophora brassica, Rhizoctonia species, for example Rhizoctonia solani, Sarocladium species, for example Sarocladium oryzae; Sclerotium species, for example Sclerotium oryzae, Tapesia species, for example Tapesia acuformis, Thielaviopsis species, for example Thielaviopsis basicola, ear and panicle diseases (including corn cobs) caused, for example, by Alternaria species, for example Alternaria spp.; Aspergillus species, for example Aspergillus flavus, Cladosporium species, for example Cladosporium cladosporioides, Claviceps species, for example Claviceps purpurea, Fusarium species, for example Fusarium culmorunr, Gibberella species, for example Gibberella zeae Monographella species, for example Monographella nivalis, Stagnospora species, for example Stagnospora nodorunr, diseases caused by smut fungi, for example Sphacelotheca species, for example Sphacelotheca reiliana, Tilletia species, for example Tilletia caries or Tilletia controversy, Urocystis species, for example Urocystis occulta, Ustilago species, for example Ustilago nuda, fruit rot caused, for example, by Aspergillus species, for example Aspergillus flavus, Botrytis species, for example Botrytis cinerea, Monilinia species, for example Monilinia Iaxa, Penicillium species, for example Penicillium expansum or Penicillium purpurogenum, Rhizopus species, for example Rhizopus stolonifer, Sclerotinia species, for example Sclerotinia sclerotiorum, Verticilium species, for example Verticilium alboatrum, seed- and soil-bome rot and wilt diseases, and also diseases of seedlings, caused, for example, by Alternaria species, for example Alternaria brasside ola Aphanomyces species, for example Aphanomyces euteiches, Ascochyta species, for example Ascochyta lends, Aspergillus species, or example Aspergillus flavus, Cladosporium species, for example Cladosporium herbarum, Cochliobolus species, for example Cochliobolus sativus (conidial form: Drechslera, Bipolaris Syn: Helminthosp orium), Colletotrichum species, for example Colletotrichum coccodes, Fusarium species, for example Fusarium culmorum, Gibberella species, for example Gibberella zeae Macrophomina species, for example Macrophomina phaseolina, Microdochium species, for example Microdochium nivale, Monographella species, for example Monographella nivalis, Penicillium species, for example Penicillium expansum, Phoma species, for example Phoma lingam, Phomopsis species, for example Phomopsis so ae Phytophthora species, for example Phytophthora cactorum, Pyrenophora species, for example Pyrenophora graminea, Pyricularia species, for example Pyricularia oryzac, Pythium species, for example Pythium ultimum, Rhizoctonia species, for example Rhizoctonia solanv, Rhizopus species, for example Rhizopus oryzae; Sclerotium species, for example Sclerotium rolfsii, Septoria species, for example Septoria nodorum, Typhula species, for example Typhula incarnata, Verticillium species, for example Verticillium dahliae, cancers, galls and witches' broom caused, for example, by Nectria species, for example Nectria galligena, wilt diseases caused, for example, by Verticillium species, for example Verticillium longisporunr, Fusarium species, for example Fusarium oxysporurrv, deformations of leaves, flowers and fruits caused, for example, by Exobasidium species, for example Exobasidium vexans, Taphrina species, for example Taphrina deformans, degenerative diseases in woody plants, caused, for example, by Esca species, for example Phaeomoniella chlamydospora, Phaeoacremonium aleophilum or Fomitiporia mediterranean Ganoderma species, for example Ganoderma boninense, diseases of plant tubers caused, for example, by Rhizoctonia species, for example Rhizoctonia solanv, Helminthosporium species, for example Helminthosporium solanv, diseases caused by bacterial pathogens, for example Xanthomonas species, for example Xanthomonas campestris pv. oryzae, Pseudomonas species, for example Pseudomonas syringae pv. lachrymans, Erwinia species, for example Erwinia amylovora, Liberibacter species, for example Liberibacter asiaticus, Xyella species, for example Xylella fastidiosa, Ralstonia species, for example Ralstonia solanacearum, Dickeya species, for example Dickeya solanv, Clavibacter species, for example Clavibacter michiganensis, Streptomyces species, for example Streptomyces scabies. diseases of soya beans: fungal diseases on leaves, stems, pods and seeds caused, for example, by Alternaria leaf spot (Alternaria spec atrans tenuissima), Anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.j), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), mst (Phakopsora pachyrhizi, Phakopsora meibomiae), scab (Sphaceloma glycines), stemphylium leaf blight (Stemphylium botryosum), sudden death syndrome (Fusarium virguliforme), target spot (Corynespora cassiicola). Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythiumrot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

In some embodiments, the phytopathogenic harmful fungi is selected from Septoria species, Fusarium species, Puccinia species, Erisyphe species, Drechslera species, Ramularia species, Mycosphaerella species and Rhynchosporium species.

In some embodiments, the phytopathogenic harmful fungi is selected from Puccinia recondita, Septoria tritici, Fusarium culmorum, Pyrenophora teres, Rhynchosporium secalis and Rhizoctonia solani.

In some embodiments, the locus is a field of crop, wherein the is selected from the group consisting of cotton, rice, flax, grapevines, fruit, vegetables, such as Rosaceae sp. (for example pome fruit such as apples and pears, but also stone fruit such as apricots, cherries, almonds and peaches, and berry fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, organs and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumbers), Alliaceae sp. (for example leeks, onions), Papilionaceae sp. (for example peas); main crop plants such as Gramineae sp. (for example maize, turfgrass, cereals such as wheat, rye, rice, barley, oats, sorghum/millet and triticale), Asteraceae sp. (for example sunflowers), Brassicaceae sp. (for example white cabbage, red cabbage, broccoli, cauliflower, Brussels sprouts, Pak Choi, kohlrabi, radishes, and rapeseed, mustard, horseradish and cress), Fabacae sp. (for example beans, peanuts), Papilionaceae sp. (for example soya beans), Solanaceae sp. (for example potatoes), Chenopodiaceae sp. (for example sugar beet, fodderbeet, chard, beetroot); sugarcane, poppies, olives, coconuts, cocoa, tobacco and useful plants and ornamental plants in gardens and forests; and genetically modified varieties of each of these plants, and the seeds of these plants.

In some embodiments, the crop is selected from the group consisting of wheat, rye, rice, soybean, barley, oats, sorghum/millet, triticale, maize, potatoes, cabbage, rapeseed, beans, sugarcane, peanuts, peaches and sunflowers.

For said methods, the composition, including a diluted aqueous composition, is preferably sprayed over a plant, or part thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g. by means of wax or electrostatically). In addition, the composition, including a diluted aqueous composition, may be injected into the soil.

In some embodiments, the pesticide is applied at a rate effective for controlling a pest.

In some embodiments, the pesticide is applied at a rate effective for preventing infestation of the pest.

In some embodiments, the pesticide is applied at a rate effective for curing infestation of the pest.

In some embodiments, a method of the invention is effective for preventing infestation of a pest. In some embodiments, the method is effective for curing infestation of the pest.

In some embodiments, the method is effective for increasing the pesticidal activity of the pesticide, wherein the pesticide is phthalimide fungicide.

In some embodiments, a method of the invention further comprises applying at least one additional agrochemical to a pest, a plant part, a plant, the locus, or propagation material thereof.

### Carboxamide Solvent of Formula A

### Carboxamide Solvent of Formula A

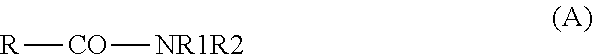

wherein R represents C8 and higher alkyl chain, R1 and R2 represent H and/or C1-C6-alkyl.

In some embodiments, R is an unbranched or branched, saturated or unsaturated.

In some embodiments, R1 and R2 are identical or different and an unbranched or branched.

In some embodiments the R is C8-C20 alkyl chain

In some embodiments, the carboxamide solvent of Formula A is N,N-dimethyl-n-octanamide, N,N-dimethyl-n-nonanamide, N,N-dimethyl-n-decanamide, N,N-dimethyl-n-decenamide N,N-dimethyl-n-dodecanamide and combination thereof.

In some embodiments the carboxamide solvent of Formula A may includes but not limited to, N,N-dimethyl-n-octanamide, N,N-dimethyl-n-decanamide and N,N-dimethyl-n-dodecanamide, in particular N,N-dimethyl-n-octanamide and N,N-dimethyl-n-decan amide.

In some embodiments, some embodiments the carboxamide solvent of Formula A is in form of mixture.

In some embodiments, the carboxamide solvent of Formula A is a mixture of different carboxamide solvents of Formula A, wherein R, R1 and R2 are as defined in the present invention.

The carboxamide solvent of Formula A can be individual structure or in the form of mixture of different carboxamide solvents of Formula A, wherein R, R1 and R2 are as defined in the present invention.

Examples of carboxamide solvent of Formula A as individual structure or mixture are known under the trade names Hallcomid, Genagen or Agnique and which consists of (unless otherwise specified, all percentages are percent by weight), for example 60-100% N,N dimethyl decanamide or for example 60-100% reaction mass of N,N-dimethyl decanamide and N,N dimethyl octanamide.

In some embodiments, the R in the carboxamide solvent of Formula A comprises between 8-20 carbon atoms.

In some embodiments, the R in the carboxamide solvent of Formula A comprises 10 carbon atoms.

In some embodiments, the R1 and R2 groups in the carboxamide solvent of Formula A are methyl.

In some embodiments, R1 and R2 are different.

In some embodiments R1 and R2 are part of cyclic group.

In some embodiments, the carboxamide solvent of Formula A is dimethyl decanamide.

In some embodiments, the dimethyl decanamide is Genagen 4296.

In some embodiments, carboxamide solvent of Formula A is dimethyl decen amide.

In some embodiments, the dimethyl decen amide is Steposol MET-10U.

In some embodiments, the carboxamide solvent of Formula A is a dimethylamide based on naturally derived fatty acids.

### Phthalimide Fungicide

In some embodiments, phthalimide fungicide is selected from the group consisting of captan, folpet, captafol and any combination thereof.

In some embodiments, phthalimide fungicide is mixture of two phthalimide fungicides.

In some embodiments, the phthalimide fungicide is captan.

In some embodiments, the phthalimide fungicide is folpet.

In some embodiments, the phthalimide fungicide is captafol.

### Co-Fungicide

In some embodiments the co-fungicide(s) is selected from the group consisting of SDHI fungicide, DMI fungicide, QoI fungicide, QiI fungicide, OoSI (quinone outside stigmatellin inhibitors), amine fungicide and any combination thereof.

In some embodiments, the co-fungicide is an SDHI fungicide.

In some embodiments, the co-fungicide is DMI fungicide.

In some embodiments, the co-fungicide is QoI fungicide.

In some embodiments, the co-dungicide is QiI fungicide.

In some embodiments, the co-fungicide is QoSI fungicide.

In some embodiments, the co-fungicide is amine fungicide.

In some embodiments, the co-fungicide is fluxapyroxad.

In some embodiments, the co-fungicide is fenpicoxamid.

In some embodiments, the QiI (quinone inside inhibitors) is selected from the group consisting of amisulbrom, cyazofamid, fenpicoxamid and any combination thereof.

In some embodiments, the QiI (quinone inside inhibitors) is amisulbrom. In some embodiments, the QiI (quinone inside inhibitors) is cyazofamid. In some embodiments, the QiI (quinone inside inhibitors) is fenpicoxamid.

In some embodiments, the QoI (quinone outside inhibitors) is selected from the group consisting of azoxystrobin, kresoxim-methyl, picoxystrobin, fluxastrobin, dimoxystrobin, pyraclostrobin, trifloxystrobin, coumoxystrobin, fenaminstrobin, pyrametostrobin, triclopyricarb, pyribencarb, pyraoxystrobin, metyltetraprole, mandestrobin, famoxadone, oryzastrobin, enoxastrobin, pyraclostrobin, fluoxastrobin, flufenostrin, flufenoxystrobin, metominostrobin, triclopyricarb; pyriminostrobin, florylpicoxamid, and any combination thereof.

In some embodiments, the QoI (quinone outside inhibitors) is azoxystrobin. In some embodiments, the QoI (quinone outside inhibitors) is kresoxim-methyl. In some embodiments, the QoI (quinone outside inhibitors) is picoxystrobin. In some embodiments, the QoI (quinone outside inhibitors) is fluxastrobin. In some embodiments, the QoI (quinone outside inhibitors) is dimoxystrobin. In some embodiments, the QoI (quinone outside inhibitors) is pyraclostrobin. In some embodiments, the QoI (quinone outside inhibitors) is trifloxystrobin. In some embodiments, the QoI (quinone outside inhibitors) is coumoxystrobin. In some embodiments, the QoI (quinone outside inhibitors) is fenaminstrobin. In some embodiments, the QoI (quinone outside inhibitors) is pyrametostrobin. In some embodiments, the QoI (quinone outside inhibitors) is triclopyricarb. In some embodiments, the QoI (quinone outside inhibitors) is pyribencarb. In some embodiments, the QoI (quinone outside inhibitors) is pyraoxystrobin. In some embodiments, the QoI (quinone outside inhibitors) is metyltetraprole. In some embodiments, the QoI (quinone outside inhibitors) is mandestrobin. In some embodiments, the QoI (quinone outside inhibitors) is famoxadone. In some embodiments, the QoI (quinone outside inhibitors) is oryzastrobin. In some embodiments, the QoI (quinone outside inhibitors) is enoxastrobin. In some embodiments, the QoI (quinone outside inhibitors) is flufenostrin. In some embodiments, the QoI (quinone outside inhibitors) is flufenoxystrobin. In some embodiments, the QoI (quinone outside inhibitors) is metominostrobin. In some embodiments, the QoI (quinone outside inhibitors) is fluoxastrobin. In some embodiments, the QoI (quinone outside inhibitors) is triclopyricarb. In some embodiments, the QoI (quinone outside inhibitors) is pyriminostrobin. In some embodiments, the QoI (quinone outside inhibitors) is florylpicoxamid

In some embodiments, the OOSI (quinone outside stigmatellin inhibitors) is ametoctradin.

In some embodiments, the SDHI (succinate dehydrogenase inhibitors) fungicide is selected from the group consisting of fluxapyroxad, penflufen, bixafen, isopyrazam, sedaxane, benzovindiflupyr, thifluzamide, isofetamid, fluopyram, pydiflumetofen, pyraziflumid, flutolanil, carboxin, boscalid, fluindapyr, penthiopyrad, isoflucypram, inpyrfluxam, furametpyr, benodanil, mepronil, fenfuram, oxycarboxin, pyrapropoyne, flubeneteram, quinofumelin and any combination thereof.

In some embodiments, the SDHI (succinate dehydrogenase inhibitors) fungicide is fluxapyroxad. In some embodiments, the SDHI (succinate dehydrogenase inhibitors) fungicide is penflufen. In some embodiments, the SDHI (succinate dehydrogenase inhibitors) fungicide is bixafen. In some embodiments, the SDHI (succinate dehydrogenase inhibitors) fungicide is isopyrazam. In some embodiments, the SDHI (succinate dehydrogenase inhibitors) fungicide is sedaxane. In some embodiments, the SDHI (succinate dehydrogenase inhibitors) fungicide is benzovindiflupyr. In some embodiments, the SDHI (succinate dehydrogenase inhibitors) fungicide is thifluzamide. In some embodiments, the SDHI (succinate dehydrogenase inhibitors) fungicide is isofetamid. In some embodiments, the SDHI (succinate dehydrogenase inhibitors) fungicide is fluopyram. In some embodiments, the SDHI (succinate dehydrogenase inhibitors) fungicide is pydiflumetofen. In some embodiments, the SDHI (succinate dehydrogenase inhibitors) fungicide is pyraziflumid. In some embodiments, the SDHI (succinate dehydrogenase inhibitors) fungicide is flutolanil. In some embodiments, the SDHI (succinate dehydrogenase inhibitors) fungicide is carboxin. In some embodiments, the SDHI (succinate dehydrogenase inhibitors) fungicide is boscalid. In some embodiments, the SDHI (succinate dehydrogenase inhibitors) fungicide is fluindapyr. In some embodiments, the SDHI (succinate dehydrogenase inhibitors) fungicide is penthiopyrad. In some embodiments, the SDHI (succinate dehydrogenase inhibitors) fungicide is isoflucypram. In some embodiments, the SDHI (succinate dehydrogenase inhibitors) fungicide is inpyrfluxam. In some embodiments, the SDHI (succinate dehydrogenase inhibitors) fungicide is furametpyr.

In some embodiments, the SDHI (succinate dehydrogenase inhibitors) fungicide is benodanil. In some embodiments, the SDHI (succinate dehydrogenase inhibitors) fungicide is mepronil. In some embodiments, the SDHI (succinate dehydrogenase inhibitors) fungicide is fenfuram. In some embodiments, the SDHI (succinate dehydrogenase inhibitors) fungicide is oxycarboxin. In some embodiments, the SDHI (succinate dehydrogenase inhibitors) fungicide is quinofumelin. In some embodiments, the SDHI (succinate dehydrogenase inhibitors) fungicide is pyrapropoyne. In some embodiments, the SDHI (succinate dehydrogenase inhibitors) fungicide is flubeneteram.

In some embodiments, the demethylation inhibitor fungicide (DMI fungicide) is selected from the group consisting of Triflumizole, ipconazole, tebuconazole, metconazole, fenbuconazole, bromuconazole, tetraconazole, flutriafol, penconazole, difenoconazole, prothioconazole, epoxiconazole, mefentrifluconazole, triticonazole, imazalil, Fenarimol, Tridemifon, Propiconazole prochloraz, lobutanil, azaconazole, etaconazole, bitertanol, fluquinconazole, myclobutanil, flusilazole, cyproconazole, triadimenol, hexaconazole, simeconazole, imibenconazole, diniconazole, pyrisoxazole and any combination thereof.

In some embodiments, the demethylation inhibitor fungicide (DMI fungicide) is ipconazole. In some embodiments, the demethylation inhibitor fungicide (DMI fungicide) is tebuconazole. In some embodiments, the demethylation inhibitor fungicide (DMI fungicide) is metconazole. In some embodiments, the demethylation inhibitor fungicide (DMI fungicide) is fenbuconazole. In some embodiments, the demethylation inhibitor fungicide (DMI fungicide) is bromuconazole. In some embodiments, the demethylation inhibitor fungicide (DMI fungicide) is tetraconazole. In some embodiments, the demethylation inhibitor fungicide (DMI fungicide) is flutriafol. In some embodiments, the demethylation inhibitor fungicide (DMI fungicide) is penconazole. In some embodiments, the demethylation inhibitor fungicide (DMI fungicide) is difenoconazole. In some embodiments, the demethylation inhibitor fungicide (DMI fungicide) is prothioconazole. In some embodiments, the demethylation inhibitor fungicide (DMI fungicide) is epoxiconazole. In some embodiments, the demethylation inhibitor fungicide (DMI fungicide) is mefentrifluconazole. In some embodiments, the demethylation inhibitor fungicide (DMI fungicide) is triticonazole. In some embodiments, the demethylation inhibitor fungicide (DMI fungicide) is imazalil. In some embodiments, the demethylation inhibitor fungicide (DMI fungicide) is prochloraz. In some embodiments, the demethylation inhibitor fungicide (DMI fungicide) is lobutanil. In some embodiments, the demethylation inhibitor fungicide (DMI fungicide) is azaconazole. In some embodiments, the demethylation inhibitor fungicide (DMI fungicide) is etaconazole. In some embodiments, the demethylation inhibitor fungicide (DMI fungicide) is bitertanol. In some embodiments, the demethylation inhibitor fungicide (DMI fungicide) is fluquinconazole. In some embodiments, the demethylation inhibitor fungicide (DMI fungicide) is myclobutanil. In some embodiments, the demethylation inhibitor fungicide (DMI fungicide) is flusilazole. In some embodiments, the demethylation inhibitor fungicide (DMI fungicide) is cyproconazole. In some embodiments, the demethylation inhibitor fungicide (DMI fungicide) is triadimenol. In some embodiments, the demethylation inhibitor fungicide (DMI fungicide) is hexaconazole. In some embodiments, the demethylation inhibitor fungicide (DMI fungicide) is simeconazole. In some embodiments, the demethylation inhibitor fungicide (DMI fungicide) is imibenconazole. In some embodiments, the demethylation inhibitor fungicide (DMI fungicide) is diniconazole. In some embodiments, the demethylation inhibitor fungicide (DMI fungicide) is pyrisoxazole.

In some embodiments, the amine fungicide is selected from the group consisting of fenpropidin, spiroxamine and any combination thereof. In some embodiments, the amine fungicide is a morpholine fungicide.

In some embodiments, the co-fungicide has low solubility in aromatic solvents (such as Solvesso 200), mineral oils, vegetable/methylated vegetable oils.

In some embodiments, the solubility of the co-fungicide is at least 5% w/w based on the total weight of the carboxamide solvent of Formula A.

In some embodiment R as described in the present invention is an unbranched or branched, saturated or unsaturated.

In some embodiments, R1 and R2 as described in the present invention are identical or different and an unbranched or branched.

In some embodiments, the R as described in the present invention is C8-C20 alkyl chain.

In some embodiments, R1 and R2 are part of cyclic group.

Each embodiment disclosed herein is contemplated as being applicable to each of the other disclosed embodiments. Thus, all combinations of the various elements described herein are within the scope of the invention. In addition, when lists are provided, the list is to be considered as a disclosure of any one member of the list.

This invention will be better understood by reference to the Experimental Details which follow, but those skilled in the art will readily appreciate that the specific experiments detailed are only illustrative of the invention as described more fully in the claims which follow thereafter. The invention is illustrated by the following examples without limiting it thereby.

### Experimental Section

### General Procedure:

1) Preparing two compositions, one is SC comprising phthalimide fungicide and the second is EW composition comprising fluxapyroxad.
2) Combining the two compositions to obtain SE composition.

### Materials:

PolyAgro A—PolyAgro A is a di-block copolymer, with a total weight of 17000 g/mol, composed of a hydrophobic block (Anchor block—ANCHOR) and a hydrophilic block (Stabilizing block—STAB). The stabilizing, hydrophilic, block is made of sodium 2-Acryloylamino-2-methylpropane-1-sulfonate (AMPS) monomers, which are 77% of the overall monomers in the polymer. The other 23% of the monomers belongs to the anchor, hydrophobic, block which is made of ethyl acrylate monomers. The total amount of monomers in the polymer (degree of polymerization, DPn) is 85 monomers.

This polymer may be obtained according to the following procedure.

### a) Macro CTA

Into a 2 L double jacketed reactor equipped with mechanical agitator and reflux condenser was added 11.26 g of O-ethyl-S-(1-methoxycarbonylethyl)xanthate (CH3CH(CO2CH3))S(C═S)OEt), 264.08 g of Ethanol, and 356.32 g of De-ionized water and 1400 g of AMPS(Na) solution (50% active) and 1.52 g of 4,4′-Azobis(4-cyanopentanoic acid). The reactor contents were heated to 70° C. under agitation and nitrogen. The reaction mixture was aged at 70° C. for a further hour whereupon it was cooled to ambient temperature and discharged. The measured solids content was 37.6% (115° C., 60 mins). GPC Mals: Mn=16300 Mw=2600 IP=1.6.

### b) Chain Extension

Into a 5 L double jacketed reactor equipped with mechanical agitator and reflux condenser was added 2127 g of macro CTA solution (see a) and 330 g of de-ionized water. The reactor contents were heated to 70° C. under agitation and a nitrogen stream.

Once 70° C. was reached, 106.67 g of ethyl acrylate (EA) was added over 2H00 and a 37.37 g of a solution of 10 wt % of 4,4′-Azobis(4-cyanopentanoic acid) was concomitantly added over 2 h30. After the end of the introduction of the initiator solution, the reaction solution was further aged for one hour. Thereafter a shot of 44.85 g of a 10 wt % solution of 4,4′-Azobis(4-cyanopentanoic acid) was added and the mixtue aged at 70° C. for a further hour whereupon it was cooled to ambient temperature and discharged. The measured solids content was 40.0% (115° C., 60 mins).

Ethanol was removed from the polymer solution using a rotary evaporator. Water was back added to achieve a polymer solution with a final solids content of 40.4%. 2600 g of polymer solution was placed in a 5 L double jacketed reactor equipped with mechanical agitator and reflux condenser. The pH of the solution was increased to 8.5 using a 50% solution of NaOH. The mixture was heated to 70° C. with stirring whereupon 48.4 of a 30% solution of hydrogen peroxide was added in 1 hour. At the end of the additions, the solution was aged for a further 3 h00 whereupon it was cooled and discharged.

The residuals monomers were measure by HPLC and GC (AMPS=22 ppm, EA=2 ppm).

The measured solids content was 37.5%. The polymer is used in the composition of the present invention as a ready aqua polymer solution at concentration of about 30% w/w.

### PolyAgro A:

| | | | | Total | STAB | ANCHOR | | |
|---|---|---|---|---|---|---|---|---|
| AMPS | EA | AMPS | EA | Mnth | Mnth | Mnth | Dpn | Dpn |
| (mol %) | (mol %) | (wt %) | (wt %) | (g/mol) | (g/mol) | (g/mol) | STAB | ANCHOR |
| 77 | 23 | 88 | 12 | 17000 | 15000 | 2000 | 65 | 20 |

### Example 1

The exact composition and ingredients weight % that were used for preparation are described in Table 1.

TABLE 1

| | % w/w | gr/L |
|---|---|---|
| Folpet tech (as 100% pure) | 29.0 | 339.3 |
| Polyagro A | 3.7 | 43.3 |
| Atlas 5002G | 1.0 | 11.7 |
| Tersperse 2500 | 0.7 | 7.6 |
| Lankropol KO2 | 0.7 | 7.6 |
| SAG 1572 | 0.1 | 1.5 |
| propylene glycol | 5.6 | 65.8 |
| water | 36.9 | 431.3 |
| Citric acid | 1.0 | 11.7 |
| 50% KOH | 1.5 | 17.6 |
| Xanthan gum | 0.1 | 58.2 |
| Van Gel B | 0.4 | 4.6 |
| Fluxapyroxad tech (as 100% pure) | 3.5 | 41.0 |
| Genagen 4296 | 15.4 | 180.2 |
| Soprophor ts-10 | 0.4 | 4.1 |

Density 1.17; pH 3-5; viscosity 900-2000 cP

### Preparation of Example 1

### Preparation of Folpet Composition (SC) According to Table 2:

TABLE 2

| | % | g/L |
|---|---|---|
| Folpet tech (as 100% pure) | 44.5 | 565 |
| Polyagro A | 3 | 38.1 |
| Atlas 5002G | 1 | 12.7 |
| Tersperse 2500 | 1 | 12.7 |
| Lankropol KO2 | 1 | 12.7 |
| SAG 1572 | 0.2 | 2.54 |
| propylene glycol | 6.5 | 82.6 |
| water | 39.6 | 502.4 |
| Citric acid | 1 | 12.7 |
| 50% KOH | 1.5 | 19.1 |
| Xanthan gum | 0.15 | 1.9 |
| Van Gel B | 0.6 | 7.6 |
| subtotal | 100.0 | 1270.0 |

density 1.27 g/ml

Van gel B was added to water and sheared for 10 min to fully disperse the silicate. Buffer, antifreeze, surfactants and antifoam were added and mixed until homogeneous. Folpet was added and milled in a bead mill to reduce the particle size. Xanthan gum was added.

### Preparation of Fluxapyroxad Composition (EW) According to Table 3:

TABLE 3

| | % w/w | gr/L |
|---|---|---|
| Fluxapyroxad tech (as 100% pure) | 10.0 | 100 |
| Genagen 4296 | 44 | 440 |
| TS 10 | 1 | 10 |
| Polyagro A | 5 | 50 |
| PG | 4 | 40 |
| Atlas G 5002L | 1 | 10 |
| water | 32.4 | 324 |
| citric acid | 1.0 | 10 |
| 50% KOH | 1.5 | 15 |
| Xanthan gum | 0.1 | 1 |
| subtotal | 100.0 | 1000.0 |

Density 1 g/ml.

Organic phase was prepared by mixing the solvent with the AI and emulsifier (TS 10). Water phase was prepared by mixing water, buffer, antifreeze, and surfactants. The phases were combined and sheared to reduce droplet size. Xanthan gum was added.

### Preparation of the SE Composition Comprising Folpet and Fluxapyroxad:

The two compositions were mixed according to table 4.

TABLE 4

| | % w/w | gr/L |
|---|---|---|
| Fluxapyroxad EW | 35.0 | 409.5 |
| Folpet SC | 65.0 | 760.5 |

### Example 2

The composition prepared is described in Table 5.

TABLE 5

| | % | g/L |
|---|---|---|
| Folpet tech (as 100% pure) | 28.9 | 337.8 |
| polyagro A | 3.8 | 44.9 |
| Atlas 5002G | 1.0 | 11.7 |
| Tersperse 2500 | 0.6 | 6.8 |
| Lankropol KO2 | 0.6 | 5.8 |
| SAG 1572 | 0.1 | 1.4 |
| propylene glycol | 5.5 | 63.8 |
| Citric acid | 1.0 | 11.7 |
| 50% KOH | 1.5 | 17.6 |
| Xanthan gum | 0.1 | 1.4 |
| Van Gel B | 0.3 | 4.1 |
| Soft water | 31.5 | 368.6 |
| Fluxapyroxad tech (as 100% pure) | 3.5 | 41.0 |
| Aerosol OT- SE | 0.2 | 2.4 |
| Genagen 4296 | 21.4 | 250.0 |

Density 1.17 g/ml, pH 3-6, viscosity 400-1000 cP.

### Preparation of Folpet Composition (SC) According to Table 6:

TABLE 6

| | % | g/L |
|---|---|---|
| Folpet tech (as 100% pure) | 49.6 | 630.0 |
| polyagro A | 3.0 | 38.1 |
| Atlas 5002G | 1.0 | 12.7 |
| Tersperse 2500 | 1.0 | 12.7 |
| Lankropol KO2 | 1.0 | 12.7 |
| SAG 1572 | 0.2 | 2.5 |
| propylene glycol | 6.5 | 82.6 |
| Citric acid | 1.0 | 12.7 |
| 50% KOH | 1.5 | 19.1 |
| Xanthan gum | 0.1 | 1.7 |
| Van Gel B | 0.6 | 7.6 |
| Soft water | 34.5 | 437.6 |

Density 1.33 g/ml

Van gel B was added to water and sheared for 10 min to fully disperse the silicate. Buffer, antifreeze, surfactants and antifoam were added and mixed until homogeneous. Folpet was added and milled in a bead mill to reduce the particle size. Xanthan gum was added.

### Preparation of Fluxapyroxad Composition (EW) According to Table 7:

TABLE 7

| | % w/w | gr/L |
|---|---|---|
| Fluxapyroxad tech (as 100% pure) | 8.4 | 83.9 |
| Aerosol OT- SE | 0.5 | 5.0 |
| polyagro A | 5.0 | 50.0 |
| PG | 4.0 | 40.0 |
| Citric acid | 1.0 | 10.0 |
| KOH 50% | 1.5 | 15.0 |
| Atlas G 5002L | 1.0 | 10.0 |
| Xanthan gum | 0.1 | 1.1 |
| Genagen 4296 | 51.1 | 511.1 |
| water | 27.4 | 273.9 |

Density 1 g/ml

Organic phase was prepared by mixing the solvent with the AI and emulsifier (Aerosol OT-SE). Water phase was prepared by mixing water, buffer, antifreeze, and surfactants. The phases were combined and sheared to reduce droplet size. Xanthan gum was added.

### Preparation of the SE Composition Comprising Folpet and Fluxapyroxad:

The two compositions were mixed according to table 8.

TABLE 8

| | % | g/L |
|---|---|---|
| Fluxapyroxad EW | 41.8 | 488.6 |
| Folpet SC | 58.2 | 681.4 |

### Example 3

The composition prepared is described in Table 9.

TABLE 9

| | % | g/L |
|---|---|---|
| Folpet tech (as 100% pure) | 28.9 | 337.8 |
| polyagro A | 3.8 | 44.9 |
| Atlas 5002G | 1.0 | 11.7 |
| Tersperse 2500 | 0.6 | 6.8 |
| Lankropol KO2 | 0.6 | 6.8 |
| SAG 1572 | 0.1 | 1.4 |
| propylene glycol | 5.5 | 63.8 |
| Citric acid | 1.0 | 11.7 |
| 50% KOH | 1.5 | 17.6 |
| Xanthan gum | 0.1 | 1.4 |
| Van Gel B | 0.3 | 4.1 |
| Soft water | 31.5 | 368.6 |
| Fluxapyroxad tech (as 100% pure) | 3.5 | 41.0 |
| Atlox 4912 | 0.4 | 4.9 |
| Aerosol OT- SE | 0.2 | 2.4 |
| Genagen 4296 | 20.9 | 245.1 |

Density 1.17 g/ml, pH 3-6, viscosity 350-1000 cP

Folpet composition (SC) was prepared as for example 2.

### Preparation of Fluxapyroxad Composition (EW) According to Table 10:

TABLE 10

| | % w/w | gr/L |
|---|---|---|
| Fluxapyroxad tech (as 100% pure) | 8.4 | 83.9 |
| Atlox 4912 | 1.0 | 10.0 |
| Aerosol OT- SE | 0.5 | 5.0 |
| Polyagro A | 5.0 | 50.0 |
| PG | 4.0 | 40.0 |
| Citric acid | 1.0 | 10.0 |
| KOH 50% | 1.5 | 15.0 |
| Atlas G 5002L | 1.0 | 10.0 |
| Xanthan gum | 0.1 | 1.1 |
| Genagen 4296 | 50.1 | 501.1 |
| water | 27.4 | 273.9 |

Density 1 g/ml

Organic phase was prepared by mixing the solvent with the AI and emulsifiers (Aerosol OT-SE, Atlox 4912). Water phase was prepared by mixing water, buffer, antifreeze, and surfactants. The phases were combined and sheared to reduce droplet size. Xanthan gum was added.

### Preparation of the SE Composition Comprising Folpet and Fluxapyroxad:

The two compositions were mixed according to the table 11.

TABLE 11

| | % w/w | g/L |
|---|---|---|
| Fluxapyroxad EW | 41.8 | 488.6 |
| Folpet SC | 58.2 | 681.4 |

The stability of the compositions of examples 1-3, comprising carboxamide solvent of Formula A were tested before and after accelerated storage (54° C. for 2 weeks), and pH remained between 3-6, no sedimentation was observed, dispersion stability (CIPAC MT 180) didn't change significantly, wet sieve residue (CIPAC MT 185) was negligible.

### Example 4. Captan and Fluxapyroxad SE

TABLE 12

| | % w/w | g/L |
|---|---|---|
| Captan tech | 30.51 | 360 |
| Fluxapyroxad tech | 2.54 | 30 |
| Acetic Acid | 0.38 | 4.5 |
| xanthan gum | 0.14 | 1.7 |
| Atlox 4913 | 1.36 | 16 |
| BREAK-THRU S 240 | 0.95 | 11.2 |
| CAB-O-SIL M5a | 1.88 | 22.2 |
| CO-40 | 1.25 | 14.7 |
| Polyagro A | 2.82 | 33.3 |
| Nansa EVM 63/B | 1.04 | 12.3 |
| Propylene glycol | 3.81 | 45 |
| Proxel GXL | 0.15 | 1.8 |
| SAG 1572 | 0.51 | 6 |
| sodium acetate | 2.17 | 25.6 |
| Soprophor FL | 1.07 | 12.6 |
| STEPOSOL MET-10U | 9.69 | 114.4 |
| Water | Up to 100% | Up to 1000 L |

### 1. Sc Preparation:

Atlox 4913, Soprophor FL, Acetic acid, Sodium Acetate, Proxel GXL, Propylene glycol, Polyagro A and SAG 1572 were added to water and mixed until homogeneous. Captan was added and milled in a bead mill to reduce the particle size. Xanthan gum was added.

### 2. Organic Phase Preparation:

Solvent was mixed with Fluxapyroxad and emulsifiers (CO-40, Nansa EVM 63/B) until fully dissolved.

### 3. Emulsion Preparation:

Water phase was prepared by mixing water and SAG 1572. The phases were combined and sheared to reduce droplet size.

### 4. SE Preparation:

EW and SC were combined. Break Thru S 240 was added and mixed until homogeneous. Cab 0 Sil M was added and sheared until uniformly dispersed. Xanthan gum was added.

The pH of the composition was tested before and after accelerated storage for 2 weeks at 54 and remained between 3.5-5.5.

### Example 5, Without Using the Carboxamide Solvent of Formula A

The composition prepared is described in Table 13.

TABLE 13

| | % | g/L |
|---|---|---|
| Folpet tech (as 100% pure) | 28.9 | 338 |
| polyagro A | 3 | 35 |
| Tersperse 2500 | 0.64 | 7.5 |
| Lankropol KO2 | 0.64 | 7.5 |
| SAG 1572 | 0.13 | 1.5 |
| propylene glycol | 6.5 | 76 |
| Citric acid | 0.64 | 7.5 |
| 50% KOH | 1.2 | 14 |
| Xanthan gum | 0.1 | 1 |
| Soft water | 37.5 | 439 |
| Fluxapyroxad tech (as 100% pure) | 3.5 | 41.0 |
| Soprophor TS/10 | 0.7 | 8 |
| Synperonic PE/F68 | 0.43 | 5 |
| N-Octyl Pyrrolidone | 16.75 | 196 |

The pH of the composition which was tested after 2 weeks storage at 54° C., was dropped to below 1.

### Example 6. Phytotoxicity Test

The trial was carried out on apple, in Busca, Piedmont Region (Northern Italy), in 2022. Tested product, example 4 was compared to the tank mixture of reference products MERPAN 480 L (captan 480 g a.i./L, SC) and SERCADIS (fluxapyroxad 300 g a.i./L, SC). Six foliar applications of tested and reference products were performed during the trial period starting from 12th of April till 4th of June with interval between applications of 9-12 days.

In presence of moderate Venturia inaequalis disease pressure example 4 showed efficacy of 93% on leaves and 95.4% on fruits in disease control.

In table 14, some light phytotoxicity in form of leaf necrotic spots was observed during the trial period in both tank mix (SC) and prototype example 4.

TABLE 14

| | | | Phyto- | Phyto- |
|---|---|---|---|---|
| | | | toxicity | toxicity |
| | | | on apple | on apple |
| | | | as necrotic | as necrotic |
| | | | spots on | spots on |
| | | | leaves - % | leaves - % |
| | formulation | | of affected | of affected |
| Treatment | type | Amount of AI/ha | leaves | leaf area |
| Untreated | | | 0b | 0c |
| Check | | | | |
| Merpan | SC | Captan 900 g/ha + | 4.1a | 0.82a |
| 480 SC + | SC | Fluxapyroxad | | |
| Sercadis | | 75 g/ha | | |
| Example 4 | SE | Captan 900 g/ha + | 4a | 0.38abc |
| | | Fluxapyroxad | | |
| | | 75 g/ha | | |

1. A composition comprising (1) an amount of phthalimide fungicide, (2) an amount of at least one co-fungicide, (3) water and (4) an amount of carboxamide solvent having the structure of Formula A 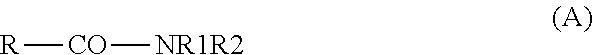
wherein R represents C8 and higher alkyl chain, R1 and R2 represent H and/or C1-C6-alkyl.

2. A composition comprising (1) an amount of phthalimide fungicide, (2) an amount of at least one co-fungicide (3) water and (3) an amount of carboxamide solvent of Formula A, 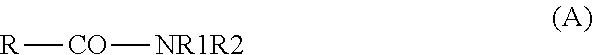
wherein:
(a) R represents C8 and higher alkyl chain, R1 and R2 represent H and/or C1-C6-alkyl;
(b) the phthalimide fungicide is suspended in the water; and
(c) the co-fungicide is dissolved in the carboxamide solvent of Formula A.

3. The composition of claim 1 or 2, wherein the composition further comprising non polar solvent.

4. The composition of any one of claims 1-3, wherein R is an unbranched or branched, saturated or unsaturated.

5. The composition of any one of claims 1-3, wherein R1 and R2 are identical or different and an unbranched or branched.

6. The composition of any one of claims 1-3, wherein R is C8-C20 alkyl chain

7. The composition of any one of claims 1-6, wherein the carboxamide solvent of Formula A is dimethyl decanamide.

8. The composition of any one of claims 1-7, wherein the amount of the phthalimide fungicide in the composition is between about 1% to about 90% w/w based on the total weight of the composition.

9. The composition of claim 8, wherein the amount of the phthalimide fungicide in the composition is between about 25% to about 35% w/w based on the total weight of the composition.

10. The composition of claim 9, wherein the amount of the phthalimide fungicide in the composition is about 30% w/w based on the total weight of the composition.

11. The composition of any one of claims 1-10, wherein the amount of the co-fungicide in the composition is between about 1.25% to about 30% w/w based on the total weight of the composition.

12. The composition of claim 11, wherein the amount of the co-fungicide in the composition is about 2.5% to about 3.5% % w/w based on the total weight of the composition.

13. The composition of any one of claims 1-12, wherein the amount of the carboxamide solvent of Formula A in the composition is between about 5% to 50% w/w based on the total weight of the composition.

14. The composition of claim 13, wherein the amount of the carboxamide solvent of Formula A in the composition is about 8% to about 15% w/w based on the total weight of the composition.

15. The composition of any one of claims 1-14, wherein the amount of water in the composition is between about 20% to 90% w/w based on the total weight of the composition.

16. The composition of claim 15, wherein the amount of water in the composition is about 35% w/w based on the total weight of the composition.

17. The composition of any one of claims 1-16, wherein the weight ratio between the phthalimide fungicide and the carboxamide solvent of Formula A is about 1.7:1.

18. The composition of any one of claims 1-16, wherein the weight ratio between the phthalimide fungicide and the carboxamide solvent of Formula A is about 1.8:1.

19. The composition of any one of claims 1-16, wherein the weight ratio between the phthalimide fungicide and the carboxamide solvent of Formula A is between 1.75:1 to 2.2:1.

20. The composition of any one of claims 1-19, wherein the weight ratio between the carboxamide solvent of Formula A to the co-fungicide is between about 3:1 to about 10:1.

21. The composition of claim 20, wherein the weight ratio between the carboxamide solvent of Formula A to the co-fungicide is between about 4:1 to about 8:1.

22. The composition of claim 20, wherein the weight ratio between the carboxamide solvent of Formula A to the co-fungicide is between about 4:1 to about 7:1.

23. The composition of any one of claims 1-22, wherein the phthalimide fungicide is folpet.

24. The composition of any one of claims 1-22, wherein the phthalimide fungicide is captan.

25. The composition of any one of claims 1-24, wherein the co-fungicide is fluxapyroxad.

26. The composition of any one of claims 1-24, wherein the co-fungicide is fenpicoxamid.

27. The composition of any one of claims 1-26, wherein the composition further comprises at least one surfactant.

28. The composition of any one of claims 1-26, wherein the composition comprises at least two surfactants.

29. The composition of claim 27 or 28, wherein the amount of the surfactant(s) in the composition is between about 3% to about 15% w/w based on the total weight of the composition.

30. The composition of claim 29, wherein the amount of the surfactant(s) is about 6.5% to about 8.5% w/w based on the total weight of the composition.

31. The composition of any one of claims 27-30, wherein the surfactant is dispersing agent, emulsifier and/or wetting agent.

32. The composition of claim 31, wherein the dispersing agent is selected from the group consisting of polyglycol ethers, Polyalkylene oxide block copolymer (such as atlas G5002L), ethoxylated fatty alcohol, castor oil ethoxylate, ethoxylated aryl alcohol, their ether phosphates and salts thereof (such as amine salt of Polyarylphenyl ether phosphate), ethoxylated tristyryl phenol, Poly-ether modified Trisiloxane, methyl methacrylate-polyethylene glycol graft copolymer (such as atlox 4913 and tersperse 2500), condensate of alkyl naphthalene sulfonate formaldehyde, lignosulfonates, silicone surfactant, methyl naphthalene sulfonate condensate, sodium salt, polyelectrolyte block copolymer (as described in WO2017/098325) and any combination thereof.

33. The composition of claim 31, wherein the surfactant is emulsifier agent.

34. The composition of claim 33, wherein the emulsifier agent is selected from a group of Sodium Dioctyl sulfosuccinate (such as aerosol OT-SE), Soprophor ts-10 (ethoxylated tristyryl phenol), Atlox 4912 (ABA Block copolymer), alkylated Benzenesulfonic acid calcium salt, Castor oil ethoxylate and any combination thereof.

35. The composition of claim 33 or 34, the amount of emulsifier agent which is dissolved in the carboxamide solvent of Formula A is up to about 2% w/w based on the total weight of the composition.

36. The composition of any one of claims 1-35, wherein the pH of the composition is between 3 and 6.

37. The composition of any one of claims 1-36, wherein the composition further comprises buffer system.

38. The composition of claim 37, wherein the buffer system is a combination of citric acid and a base such as citrate salt, hydroxide salt.

39. The composition of claim 37, wherein the buffer system is a combination of acetic acid and a base such as acetate salt, hydroxide salt.

40. The composition of any one of claims 37-39, wherein the amount of the buffer system is between 1% to about 5% w/w based on the total weight of the composition.

41. The composition of any one of claims 1-40, wherein the composition further comprises rheological modifier.

42. The composition of claim 41, wherein the rheological modifier is clay based rheological modifier additive such as Van Gel B (Magnesium Aluminum Silicate).

43. A process for preparing a composition comprising phthalimide fungicide, at least one co-fungicide, water and carboxamide solvent of Formula A, 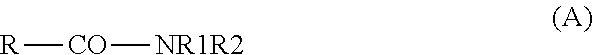
wherein R represents C8 and higher alkyl chain, R1 and R2 represents H and/or C1-C6-alkyl;
the process comprising:
(1) preparing at least two separated compositions (A) and (B), wherein composition (A) is suspension concentrate (SC) composition of phthalimide fungicide and at least one surfactant, and composition (B) comprising co-fungicide, carboxamide solvent of Formula A and at least one surfactant, wherein the co fungicide is dissolved in carboxamide solvent of Formula A; and
(2) mixing the two compositions (A) and (B) to obtain suspo-emulsion composition (SE).

44. A method of controlling fungal disease comprising applying to the plant or the locus of the plant a composition comprising (1) at least one co-fungicide; (2) at least one phthalimide fungicide, (3) water and (4) carboxamide solvent of Formula A 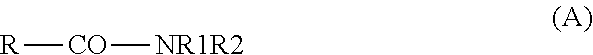
wherein: (a) R represents C8 and higher alkyl chain, R1 and R2 represent H and/or C1-C6-alkyl; (b) the phthalimide fungicide is suspended in the water and (c) the co-fungicide is dissolved in the carboxamide solvent of Formula A.

45. The method of claim 44, wherein the co-fungicide is fluxapyroxad.

46. The method of claim 44, wherein the phthalimide is captan or folpet and the co-fungicide is fluxapyroxad.

47. The method of claim 44, wherein the co-fungicide is fenpicoxamid.

48. The method of claim 44, wherein the phthalimide fungicide is captan or folpet and the co-fungicide is fenpicoxamid.
